(19) United States
(12) Patent Application Publication
(10) Pub. No.: US 2024/0327144 A1
(43) Pub. Date: Oct. 3, 2024

(54) SYSTEMS AND METHODS FOR PROCESSING OBJECTS USING AN ARTICULATED UNLOADER

(71) Applicant: Berkshire Grey Operating Company, Inc., Bedford, MA (US)

(72) Inventors: Daniel Carlton SMITH, Canonsburg, PA (US); Dominick FREEMAN, Boston, MA (US); William FARMER, Bolton, MA (US); Conor O’NEIL, Boston, MA (US); Joshua BEST, Raleigh, NC (US); Adam James DEELEY, Youngstown, OH (US); Kelvin Edward WIEBE, Harvard, MA (US); Robert WILLIAMS, Natick, MA (US); Anthony PAUL, Boston, MA (US); Joseph Corey MICHAL, Beverly, MA (US); Clayton Henry MANCHESTER, Arlington, MA (US); Michael Fangjin XIAO, Cambridge, MA (US); Ryan Edward LEONARD, Somerville, MA (US); Vitalii RUSSINKOVSKII, Lexington, MA (US); Caris Mariah MOSES, Boston, MA (US); Lakshman KUMAR, Burlington, MA (US); Nicholas ECKENSTEIN, Jamaica Plain, MA (US); Ananya TANDON, Belmont, MA (US); Thomas ALLEN, Reading, MA (US); Yanchun WU, Sharon, MA (US); Ian Michael DESROCHERS, Cambridge, MA (US); John Norman COGSWELL, III, Tewksbury, MA (US)

(21) Appl. No.: 18/620,837

(22) Filed: Mar. 28, 2024

Related U.S. Application Data
(60) Provisional application No. 63/562,970, filed on Mar. 8, 2024.
(60) Provisional application No. 63/604,634, filed on Nov. 30, 2023.
(60) Provisional application No. 63/455,158, filed on Mar. 28, 2023.

(51) Int. Cl. B65G 67/24

(52) U.S. Cl. CPC B65G 67/24

(57) ABSTRACT

An object processing system is disclosed that includes a mobile system for moving from a proximal base toward a plurality of objects to be processed, and a programmable motion device supported on the mobile unit at a proximal end of the programmable motion device, the programmable motion device including an end-effector at a distal end thereof, the end-effector including a first stationary portion that remains stationary with respect to the distal end of the programmable motion device, and a second movable portion that moves with respect to the first stationary portion, the second movable portion for contacting at least one object of the plurality of objects for urging the at least one object from the plurality of objects toward the mobile system.

### PRIORITY

The present application claims priority to U.S. Provisional Patent Application No. 63/455,158 filed Mar. 28, 2023, U.S. Provisional Patent Application No. 63/604,634 filed Nov. 30, 2023, and U.S. Provisional Patent Application No. 63/562,970 filed Mar. 8, 2024, the disclosures of each of which is hereby incorporated by reference in its entirety.

### BACKGROUND

The invention generally relates to automated, robotic and other object processing systems such as sortation systems, and relates in particular to automated and robotic systems intended for use in environments requiring, for example, that a variety of objects (e.g., parcels, packages, and articles, etc.) be processed and distributed to several output destinations.

Many parcel distribution systems receive parcels from a vehicle, such as a trailer of a tractor trailer. The parcels are unloaded and delivered to a processing station in a disorganized stream that may be provided as individual parcels or parcels aggregated in groups such as in bags, and may be provided to any of several different conveyances, such as a conveyor, or one or more pallets, Gaylords, or bins. Each parcel must then be distributed to the correct destination container, as determined by identification information associated with the parcel, which is commonly determined by a label printed on the parcel or on a sticker applied to the parcel. The destination container may take many forms, such as a bag or a bin.

The sortation of such parcels from the vehicle has traditionally been done, at least in part, by human workers that unload the vehicle, then scan the parcels, e.g., with a hand-held barcode scanner, and then place the parcels at assigned locations. For example, many order fulfillment operations achieve high efficiency by employing a process called wave picking. In wave picking, orders are picked from warehouse shelves and placed at locations (e.g., into bins) containing multiple orders that are sorted downstream. At the sorting stage individual articles are identified, and multi-article orders are consolidated, for example into a single bin or shelf location, so that they may be packed and then shipped to customers. The process of sorting these objects has traditionally been done by hand. A human sorter picks an object from an incoming bin, finds a barcode on the object, scans the barcode with a handheld barcode scanner, determines from the scanned barcode the appropriate bin or shelf location for the object, and then places the object in the so-determined bin or shelf location where all objects for that order have been defined to belong. Automated systems for order fulfillment have also been proposed, but such systems still require that objects be first removed from a vehicle for processing if they arrive by vehicle.

Such systems do not therefore, adequately account for the overall process in which objects are first delivered to and provided at a processing station by a vehicle such as a trailer of a tractor trailer. Unloading trailers by human personnel, e.g., into Gaylords or large bins, takes considerable time. Additionally, many processing stations at which the Gaylords or large bins are received are at times, at or near full capacity in terms of available floor space and sortation resources. There is a further need therefore for systems to unload vehicles and efficiently and effectively provide a more ordered flow of objects for processing.

### SUMMARY

In accordance with an aspect, the invention provides an object processing system that includes a mobile unit for moving from a proximal base toward a plurality of objects to be processed, and a programmable motion device supported on the mobile unit at a proximal end of the programmable motion device, the programmable motion device including an end-effector at a distal end thereof, the end-effector including a first stationary portion that remains stationary with respect to the distal end of the programmable motion device, and a second movable portion that moves with respect to the first stationary portion, the second movable portion for contacting at least one object of the plurality of objects for urging the at least one object from the plurality of objects toward the mobile unit.

In accordance with another aspect, the invention provides an object processing system comprising a programmable motion device with an end-effector, said end-effector comprising a conveyor section wherein the conveyor section includes features for contacting an object of a plurality of objects on an underside of the end-effector and thereby urging the object toward the programmable motion device.

In accordance with a further aspect, the invention provides a method of processing objects from a distal plurality location to a proximal base location. The method includes engaging at least one object of a plurality of objects at the distal plurality location with an underside of a conveyor section, and urging the object toward the proximal base location.

### BRIEF DESCRIPTION OF THE DRAWINGS

The following description may be further understood with reference to the accompanying drawings in which:

FIG. 1 shows an illustrative diagrammatic view of an object processing system in accordance with an aspect of the present invention that includes a mobile system for unloading a trailer of a tractor trailer;

FIGS. 2A and 2B show illustrative diagrammatic views of an end-effector of the mobile system of FIG. 1 wherein FIG. 2A shows a conveyor section of the end-effector approaching objects to be engaged, and FIG. 2B shows the conveyor section of the end-effector engaging and dislodging objects to be removed;

FIGS. 3A and 3B show illustrative diagrammatic views of the conveyor section of the end-effector of FIGS. 2A and 2B with the conveyor section pitching downward (FIG. 3A) and pitching upward (FIG. 3B);

FIG. 4 shows an illustrative diagrammatic view of the conveyor section of the end-effector of FIGS. 2A and 2B with the conveyor section rolled a small amount to one side;

FIG. 5 shows an illustrative diagrammatic view of the conveyor section of the end-effector of FIGS. 2A and 2B with the conveyor section rolled a larger amount to the other side;

FIG. 6 shows an illustrative diagrammatic view looking from the mobile system into the trailer of FIG. 1;

FIG. 7 shows an illustrative diagrammatic view looking from within the trailer of FIG. 1 toward the mobile system;

FIGS. 8A and 8B show illustrative diagrammatic views of the conveyor section of the end-effector of FIG. 1 showing the conveyor section rotated and extended toward one side of the trailer (FIG. 8A) and rotated and extended toward the other side of the trailer (FIG. 8B);

FIGS. 9A-9D show illustrative diagrammatic views of the conveyor section of the end-effector of FIG. 1 showing underside views of the conveyor section from a first position (FIG. 9A), rotated with offset rotation to ninety degrees (FIG. 9B). rotated with offset rotation a further ninety degrees (FIG. 9C), and rotated with offset rotation yet a further ninety degrees (FIG. 9D);

FIG. 10 shows an illustrative diagrammatic view of the centered conveyance system of the mobile system of FIG. 1;

FIGS. 11A and 11B show illustrative diagrammatic views of folding portion of the conveyance system of FIG. 10 showing the folding portions folded (FIG. 11A) and unfolded (FIG. 11B);

FIGS. 12A and 12B show illustrative diagrammatic views of frames for the folding portions of the conveyance system of FIGS. 11A and 11B showing the frames folded (FIG. 12A) and unfolded (FIG. 12B);

FIGS. 13A and 13B show illustrative diagrammatic views of the object processing system of FIG. 1 showing an object being dislodged onto a floor of the trailer (FIG. 13A) and showing an object being dislodged onto the conveyance system of FIG. 10;

FIG. 14 is an illustrative diagrammatic underside view of an end-effector for use in an object processing system in accordance with another aspect of the present invention;

FIG. 15 shows an illustrative diagrammatic side view of the end-effector of FIG. 14;

FIGS. 16A and 16B show illustrative diagrammatic views of the end-effector of FIG. 15 engaging an object (FIG. 16A) and dropping the object for removal by the object processing system of FIG. 14;

FIGS. 17A and 17B show illustrative diagrammatic side views of an end-effector for use in an object processing system in accordance with a further aspect of the present invention showing a pivoting vacuum head of the end-effector directed forward (FIG. 17A) and showing the pivoting vacuum head directed downward and toward one side (FIG. 17B);

FIG. 18 shows an illustrative diagrammatic view of the end-effector of FIGS. 17A and 17B used in an object processing system that includes the conveyor section end-effector of FIG. 1;

FIG. 19 shows an illustrative diagrammatic view of an object processing system in accordance with a further aspect of the present invention that includes a mobile system for unloading a trailer of a tractor trailer;

FIGS. 20A and 20B show illustrative diagrammatic views of the object processing system of FIG. 19 showing the mobile system entering a trailer of a tractor trailer (FIG. 20A) and showing an enlarged view of an underside of the object processing system (FIG. 20B);

FIGS. 21A and 21B show illustrative functional views of perception processing steps in an object processing system in accordance with an aspect of the present invention;

FIGS. 22A and 22B show illustrative diagrammatic views of partitioning systems in accordance with an aspect of the present invention showing a vertically uniform partitioning (FIG. 22A) and showing a vertically varied partitioning (FIG. 22B);

FIG. 23 shows an illustrative diagrammatic view of a front wheel drive system of a mobile system of the object processing system of FIG. 19;

FIG. 24 shows an illustrative diagrammatic view of a rear wheel steering system of the mobile system of FIG. 19;

FIGS. 25A and 25B show illustrative diagrammatic views of the front wheel drive system of FIG. 23 showing a front wheel assembly rocked in a first rotated position (FIG. 25A) and docked in a second rotated position (FIG. 25B);

FIGS. 26A and 26B show illustrative diagrammatic views of a kicker roller in the object processing system of FIG. 19 showing the kicker rollers approaching an object (FIG. 26A) and engaging an object (FIG. 26B) to urge the object onto the mobile system;

FIGS. 27A and 27B show illustrative diagrammatic views of a conveyance system of the object processing system of FIG. 19 showing a loading conveyor section at a first width (FIG. 27A) and at an expanded second width (FIG. 27B);

FIGS. 28A-28D show illustrative diagrammatic views of an articulated multi-fingered conveyor end-effector system of the object processing system of FIG. 19 showing an elevated view of the articulated multi-fingered conveyor end-effector system (FIG. 28A), showing an underside view of the articulated multi-fingered conveyor end-effector system (FIG. 28B), showing a first side view of the articulated multi-fingered conveyor end-effector system with the fingers individually articulated (FIG. 28C), and showing a second side view of the articulated multi-fingered conveyor end-effector system with the fingers individually articulated (FIG. 28D);

FIGS. 29A and 29B show illustrative diagrammatic views of the articulated multi-fingered conveyor end-effector system of FIGS. 28A-28D showing a side view of the articulated multi-fingered conveyor end-effector system (FIG. 29A) and showing an elevated view of the articulated multi-fingered conveyor end-effector system engaging objects with the fingers individually articulated (FIG. 29B);

FIGS. 30A and 30B show illustrative diagrammatic views of another end-effector system of the object processing system of FIG. 19 showing an array of vacuum cups (FIG. 30A) and showing an enlarged view of a portion of the array of vacuum cups with some vacuum conduits removed to show vacuum valves (FIG. 30B);

FIGS. 31A and 31B show illustrative diagrammatic enlarged views of vacuum valves of the system of FIG. 30B showing three valves in a closed position (FIG. 31A) and showing the three valves in an open position (FIG. 31B);

FIGS. 32A and 32B show illustrative diagrammatic views of portions of the vacuum end-effector system of FIG. 19, showing an enlarged view of a vacuum valve assembly (FIG. 32A) and showing a front view of the vacuum cup array (FIG. 32B);

FIGS. 33A-33F show illustrative diagrammatic functional views of the vacuum valves in a zone with the vacuum off (FIG. 33A), the vacuum on with no objects grasped (FIG. 33B), the vacuum on with one object attached to all vacuum cups of the zone (FIG. 33C), the vacuum on with one object only attached to some but not all of the vacuum cups of the zone (FIG. 33D), the vacuum on with two objects attached to some but not all of the vacuum cups of the zone (FIG. 33E), and the system discharging objects from the vacuum cup array (FIG. 33F);

FIGS. 34A-34C show illustrative diagrammatic partially cut-away views of the vacuum valve of FIG. 32A showing the valve open (FIG. 34A), showing the valve initially closed (FIG. 34B), and showing the valve held closed (FIG. 34C);

FIG. 35 shows an illustrative graphical representation of spring displacement in the vacuum valve of FIG. 32A verses the net force acting on the spring;

FIGS. 36A and 36B show illustrative diagrammatic views of the vacuum array end-effector system of FIG. 30A showing vacuum array end-effector grasping an object (FIG. 36A) and releasing an object onto a conveyance system (FIG. 36B) of the object processing system of FIG. 19;

FIG. 37 shows an illustrative diagrammatic view of the object processing system of FIG. 19 entering a trailer of a tractor trailer from a view from a first side of the loading dock;

FIG. 38 shows an illustrative diagrammatic view of the object processing system of FIG. 19 entering a trailer of a tractor trailer from a view from a second side of the loading dock;

FIGS. 39A and 39B show illustrative diagrammatic views from the mobile system of the object processing system of FIG. 19, showing the presence of an exception object in the trailer (FIG. 39A) and showing the exception object having been placed on the conveyance system of the mobile system (FIG. 39B);

FIGS. 40A and 40B show illustrative diagrammatic views of the conveyance system of the mobile system of FIG. 19 showing the wing sections of the loading conveyor section open (FIG. 40A) and folded (FIG. 40B);

FIG. 41 shows an illustrative diagrammatic elevated rear view of the mobile system of FIG. 19 showing the transition conveyor section;

FIG. 42 shows an illustrative diagrammatic rear view of the mobile system of FIG. 19 showing an end view of the transition conveyor section;

FIG. 43 shows an illustrative diagrammatic view of shaped kicker rollers of the mobile system of the object processing system of FIG. 19;

FIG. 44 shows an illustrative diagrammatic side sectional view of the shaped kicker rollers of FIG. 43;

FIG. 45 shows an illustrative diagrammatic view of an object being engaged by the shaped kicker roller of the mobile system of FIG. 43;

FIG. 46 shows an illustrative diagrammatic side section view of a shaped kicker roller for use in accordance with another aspect of the present invention;

FIG. 47 shows an illustrative diagrammatic side section view of a shaped kicker roller for use in accordance with a further aspect of the present invention;

FIG. 48 shows an illustrative diagrammatic side section view of a shaped kicker roller for use in accordance with a further aspect of the present invention wherein the rotational symmetry is a-symmetric;

FIG. 49 shows an illustrative diagrammatic side section view of a shaped kicker roller for use in accordance with a further aspect of the present invention wherein the kicker roller is cam-shaped in cross-section;

FIG. 50 show an illustrative diagrammatic view of a drive system for the kicker roller of the mobile system of FIG. 19 in which the drive system includes drive belts coupled to the loading conveyors;

FIG. 51 shows an illustrative diagrammatic view of a drive system for the kicker roller of the mobile system of FIG. 19 in which the drive system includes drive motors coupled to the kicker rollers;

FIG. 52 shows an illustrative diagrammatic view of the kicker roller of FIG. 43 engaging an object with aid of use of the articulated multi-fingered conveyor end-effector system of FIGS. 28A-28D; and

FIG. 53 shows an illustrative diagrammatic view of the kicker roller of FIG. 43 prepared to receive a plurality of objects with the aid of the articulated multi-fingered conveyor end-effector system of FIGS. 28A-28D.

The drawings are shown for illustrative purposes only.

### DETAILED DESCRIPTION

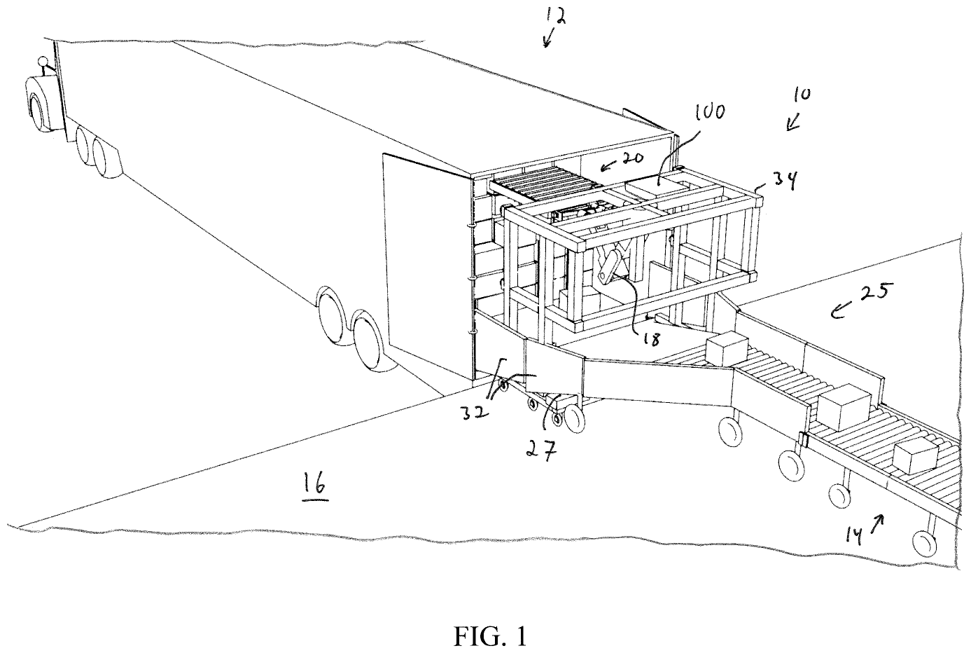

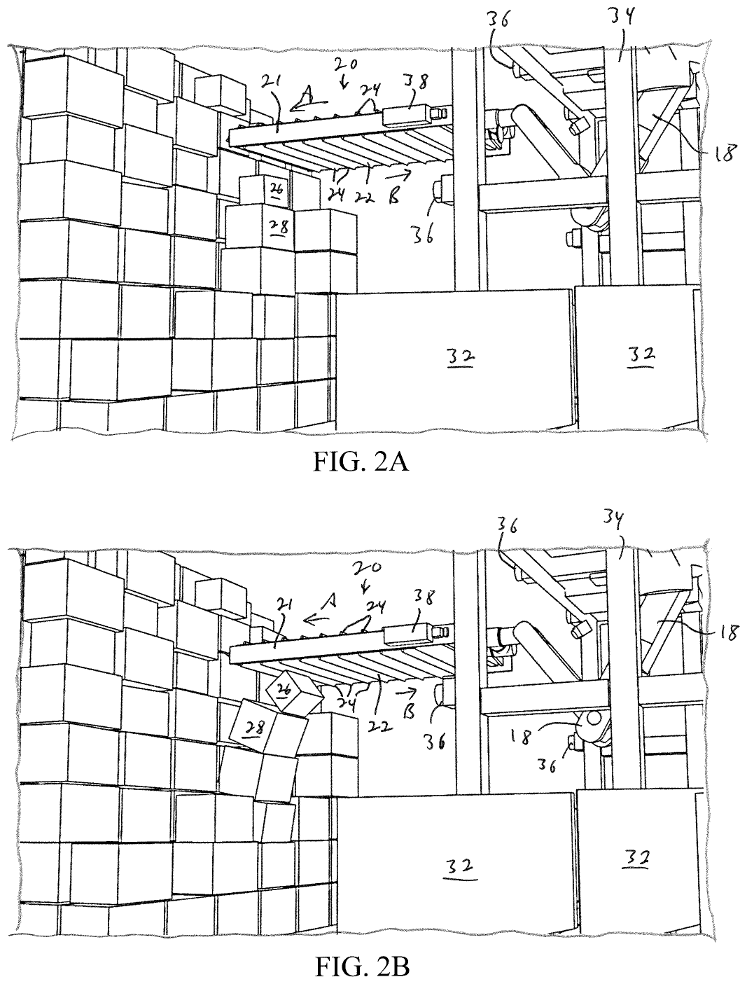

In accordance with various aspects and with reference to FIG. 1, the invention provides an object processing system 10 that processes a collection of objects within a trailer 12 of a tractor trailer and provides the objects to a receiving conveyor 14 that may be positioned, for example, on a loading dock 16. The object processing system 10 includes a programmable motion device 18 with an end-effector 20. The end-effector, for example, may be a conveyor section with a stationary frame portion 21 that is coupled to the programmable motion device, and a movable conveyor portion 22 (such as a belted conveyor) that moves with respect to the stationary frame portion 21 as further shown in FIGS. 2A and 2B. The conveyor portion is used for contacting at least one object of the collection of objects for urging the at least one object from the collection of objects toward a mobile unit 25 on which the programmable motion device is mounted. The mobile unit 25 is coupled to the receiving conveyor for providing the objects to the receiving conveyor as the mobile unit 25 and receiving conveyor 14 are moved into the trailer 12. The mobile unit 25 (together with the programmable motion device and the receiving conveyor 14 drawn behind it) may be moved into and out of the trailer 12 using one or more mobile unit motors 27. As the mobile unit 25 is moved into the trailer, the perception systems 36 (shown in FIGS. 2A and 2B) provide perception information (e.g., depth perception data, 2D or 3D scan data and/or camera image data) to assist in guiding the mobile unit 25 into the trailer.

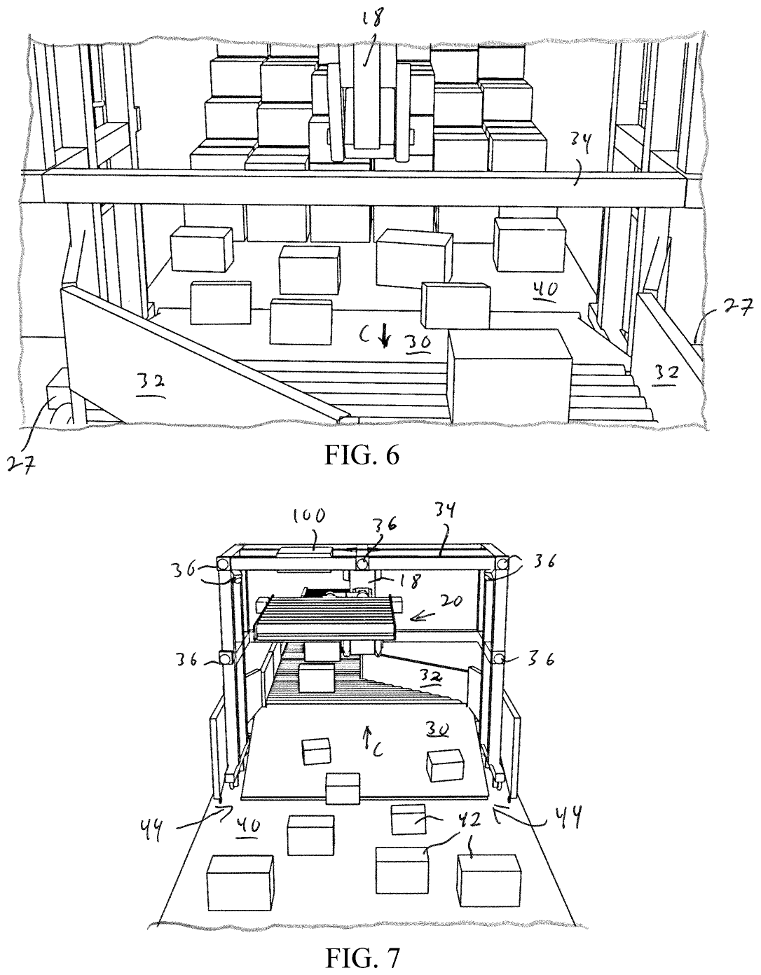

The end-effector 20 includes a conveyor 22 (such as a high friction belted conveyor) that is attached to the distal end of the programmable motion device 18 and may include features 24 (such as cleats) on the conveyor 22 as shown in FIGS. 2A and 2B (without the side walls for clarity). As the conveyor 22 moves in directions as indicated at A and B (as shown in FIG. 2A), the end-effector 20 is moved downward onto one or more objects 26 of the plurality of objects, causing the one or more objects 26, 28 to move toward the programmable motion device 18 (as shown in FIG. 2B). The objects (26 and possibly 28) will then fall to a lower level within the trailer (e.g., any of onto a floor of the trailer 12, onto a loading conveyor 30 of the mobile unit 25 or onto other objects below). The features 24 are thereby used on the underside thereof to draw objects toward the programmable motion device while the programmable motion device may or may not remain stationary, thereby falling such that they may be more easily collected by the loading conveyor 30 (shown in FIGS. 6 and 7). Guide walls 32 of the loading conveyor 30 facilitate guiding the objects toward the collection conveyor 14. The programmable motion device 18 is mounted on a structure 34 that includes perception units 36 for guiding movement of the programmable motion device 18 and end-effector 20. The system operates under the control of one or more computer processing systems 100 to provide that as the objects are dislodged by the end-effector 20 and collected by the loading conveyor 30, the mobile unit 25 moves further into the trailer.

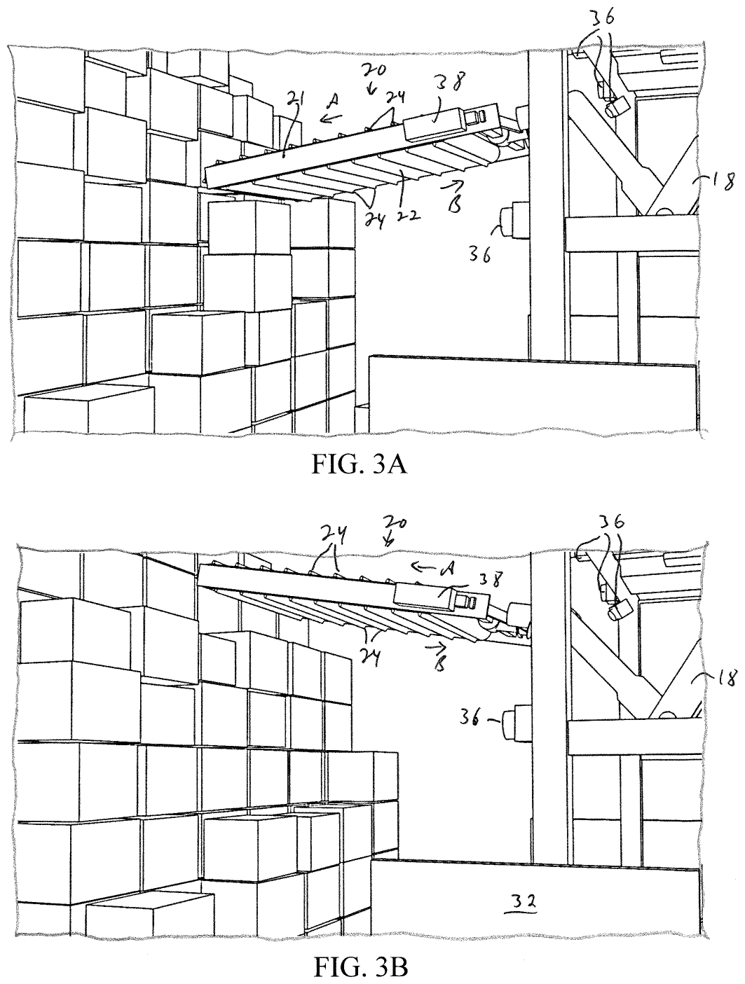

The end-effector 20 may further be pitched downward (as shown in FIG. 3A) or may be pitched upward (as shown in FIG. 3B) during processing by the programmable motion device 18. FIGS. 3A and 3B are shown without the trailer side walls for clarity. The end-effector 20 may therefore engage objects while horizontal (as shown in FIGS. 2A and 2B), while pitched upward (as shown in FIG. 3A) or while pitched upward (as shown in FIG. 3B). Pitching upward may facilitate gaining purchase on an object that is stacked particularly high, while pitching downward may permit the end-effector to more easily reach lower objects. Further, a downwardly pitched end-effector may not only apply the force of the cleats 24 on the moving conveyor 22 on the object but may also permit the end-effector 20 itself to be moved toward the structure 34 to further pull the object. The conveyor 22 may be operated in either direction by one or more conveyor motors 38.

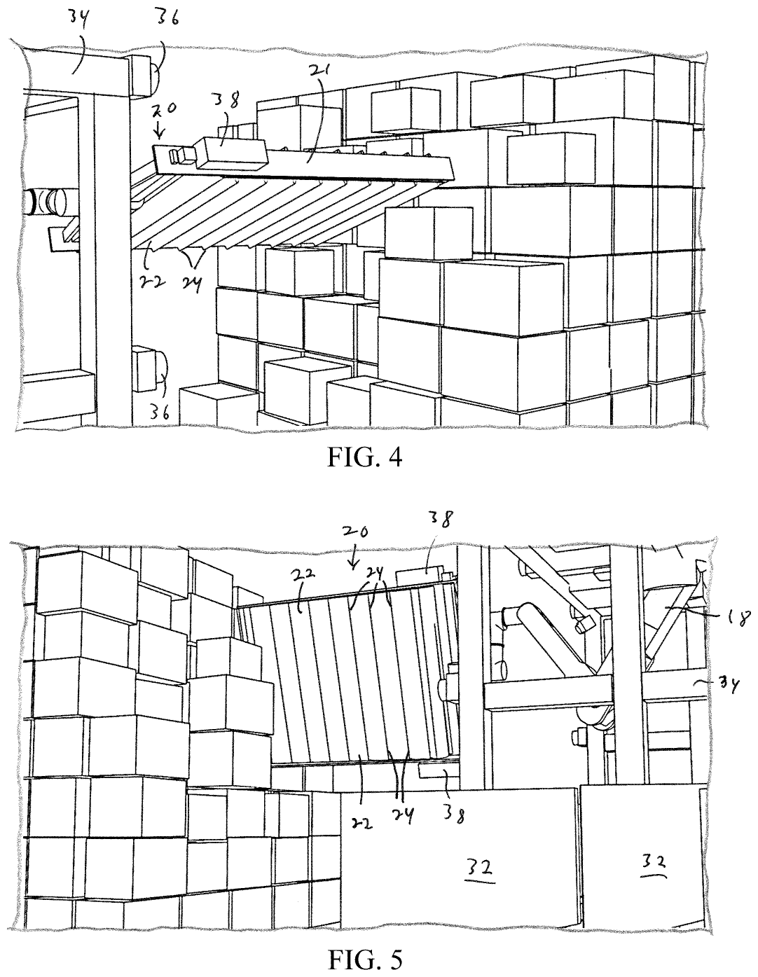

FIG. 4 shows the end-effector 20 with a small roll to one side thereof such that an edge of an adjacent object may be engaged by the underside of the end-effector. In such a position, the end-effector may be positioned to engage specific sides or edges of particular objects where such a purchase on an object may be beneficial in dislodging the object from the collection. FIG. 5 shows the end-effector 20 with a larger roll to the other side thereof such that closer to vertical sides of adjacent objects may be engaged by the underside of the end-effector. In such a position, the end-effector may be positioned to engage specific sides of particular objects such as when opposing sides of the object(s) are lodged against a wall or other solid structure. In this way, the object(s) may be pivoted against the wall or other solid structure to dislodge the object(s) from the collection.

FIG. 6 shows a view looking into the trailer 12 of objects being collected by the loading conveyor 30 of the mobile unit 25. The loading conveyor 30 travels along the floor 40 of the trailer and urges objects it contacts onto the loading conveyor. The guide walls 32 guide the objects toward the collection conveyor 14 (shown in FIG. 1). FIG. 7 shows a view looking from within the trailer 12 (without the side walls for clarity) showing that objects 42 are urged off the floor 40 and moved onto the loading conveyor 30 as they are engaged by the loading conveyor 30 as the upper surface of the loading conveyor moves in a direction as indicated at C.

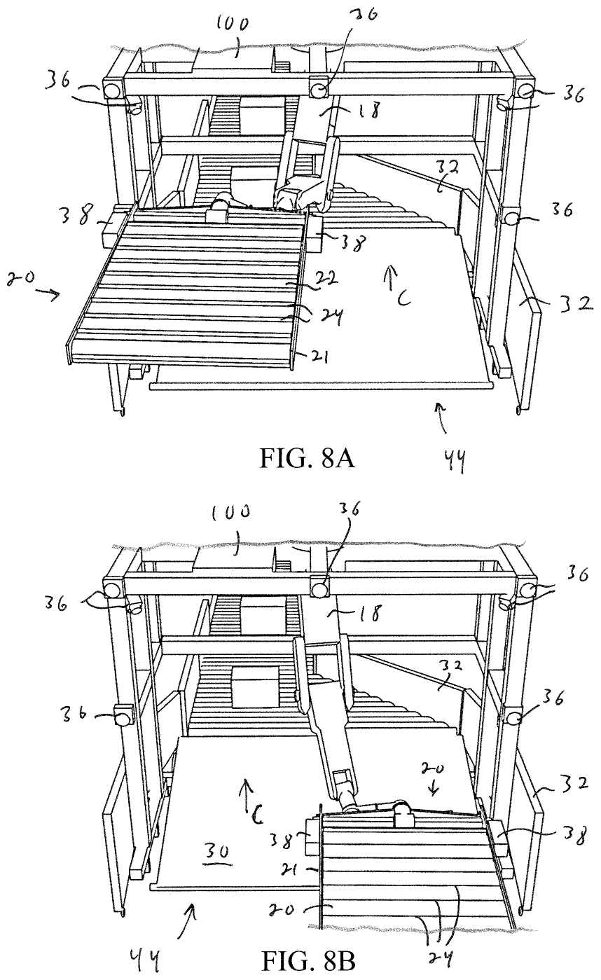

The programmable motion device 18 may be used to position the end-effector 20 at any of many locations adjacent the structure 34 within the trailer 12 as the mobile unit 25 is moved into the trailer 12. FIG. 8A shows the end-effector 20 at an elevated position to one side and FIG. 8B shows the end-effector at a lower position on an opposite side of the area adjacent the structure 34. The loading conveyor 30 may be formed of a belt conveyor material that readily engages objects. The loading conveyor 30 may further be provided on a frame that is cantilevered at its lower end 44 (shown in FIG. 7) over the trailer floor 40 such that it travels over and slightly above the trailer floor 40. In accordance with further aspects, the loading conveyor 30 may include small guide wheels at the lower end 44 of the loading conveyor 30 that cause it to travel over and slightly above the trailer floor 40.

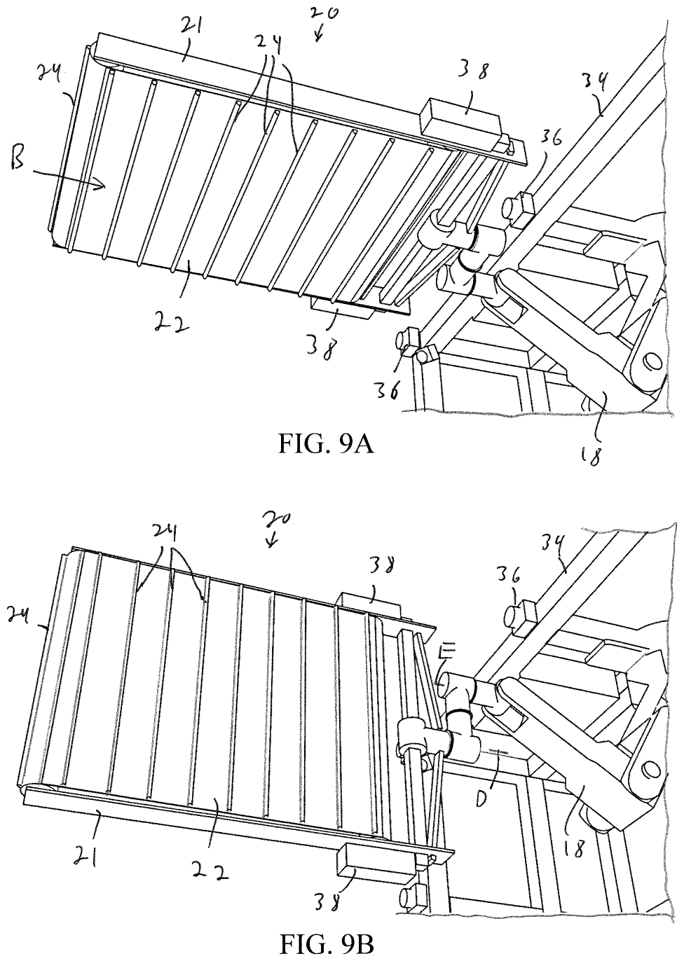

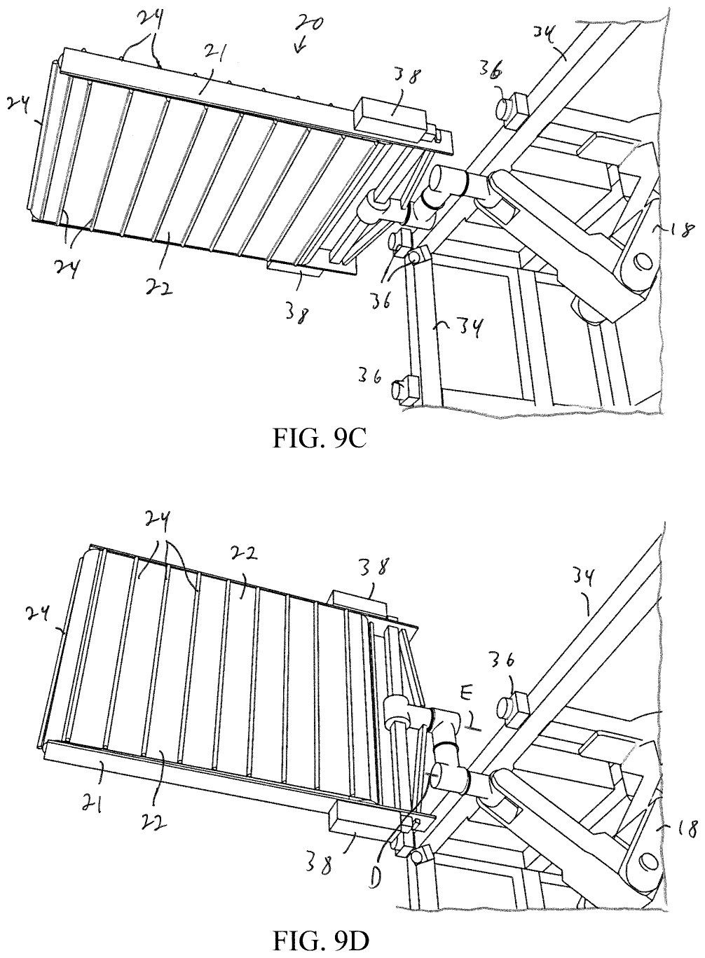

With reference to FIGS. 9A-9D, the end-effector 20 may be rotated with offset rotation a full 360 degrees with respect to the programmable motion device 18. FIG. 9A shows the conveyor moving in a direction B on the underside thereof. FIG. 9B shows the end-effector rotated 90 degrees in an upward direction, and FIG. 9C show the end-effector rotated another 90 degrees to be upside down with respect to its position in FIG. 9A. Because the conveyor 20 is exposed on both sides (top and bottom in FIG. 9A), when the end-effector is rotated 180 degrees (as shown in FIG. 9C), an opposite side is facing downward. The direction of the conveyor now reverses and the opposite side may again be used to processes objects. FIG. 9D shows the end-effector rotated another 90 degrees in a downward direction. (opposite that shown in FIG. 9B). Note that the center of rotation of the end-effector (indicated at D) with respect to the programmable motion device is offset with regard to a center of a base (indicated at E) of the programmable motion device as shown in FIGS. 9B and 9D. This permits the end-effector to be rotated as needed to more easily reach one side or the other within a trailer (using the distance of the offset between D and E.

Again, the system may operate under the control of one or more computer processing systems 100 (shown in FIG. 1) that communicate with the programmable motion device(s), the end-effector, the perception systems, the mobile unit motors and actuators, and the conveyance systems. The system provides that as the mobile unit moves into a trailer, the end-effector engages objects in the trailer and urges them onto a conveyance system. The end-effector may be positioned at various orientations and poses as discussed above to best access the objects using perception data (e.g., images, 2D or 3D scan data) from the perception units 36.

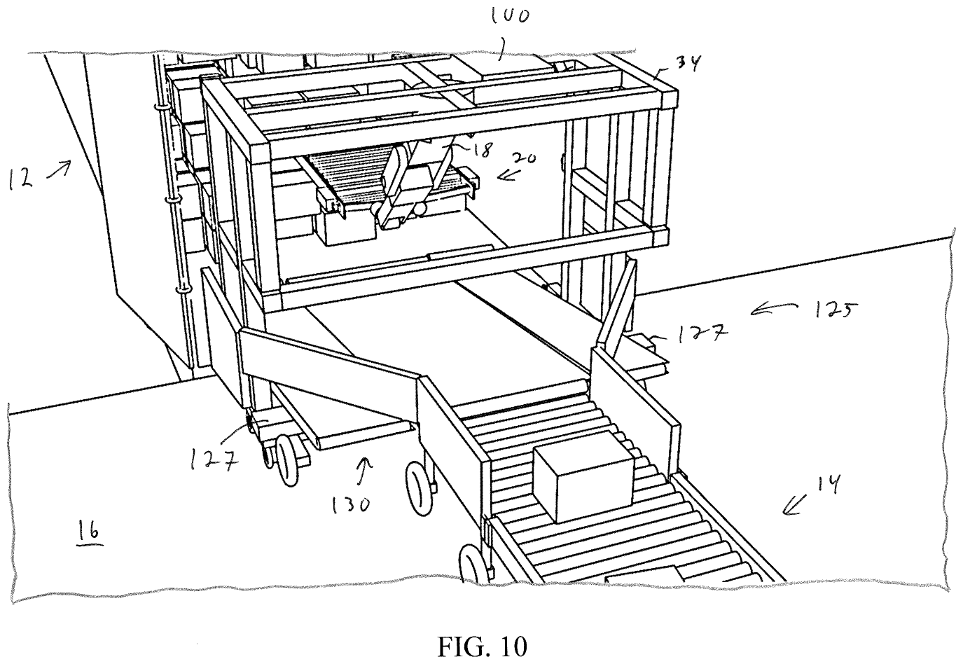

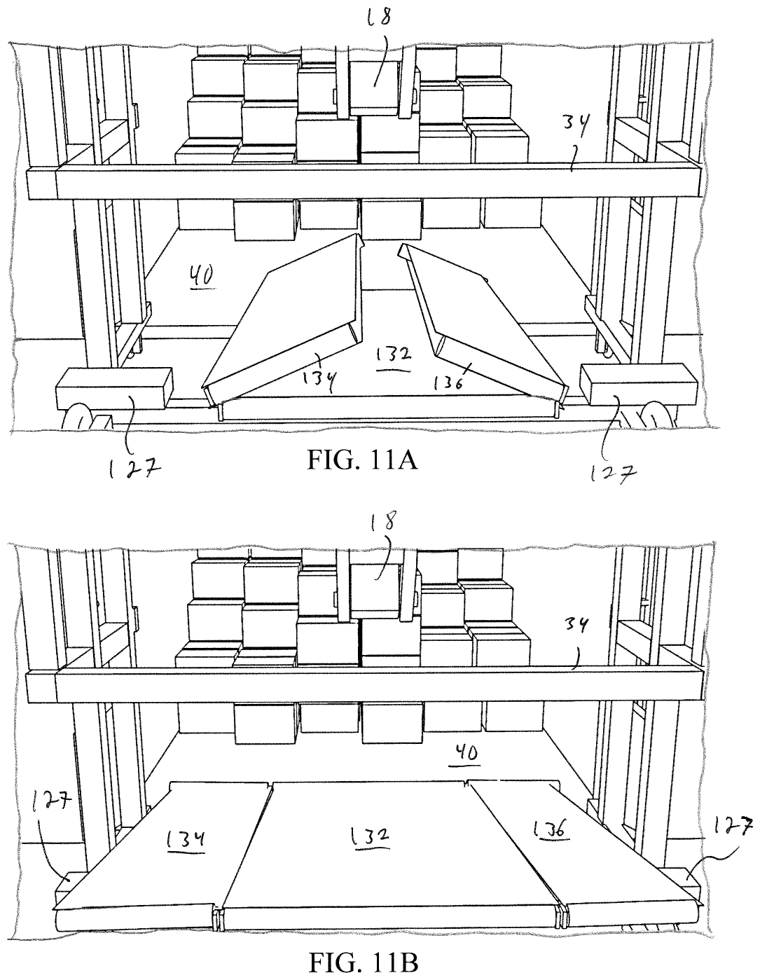

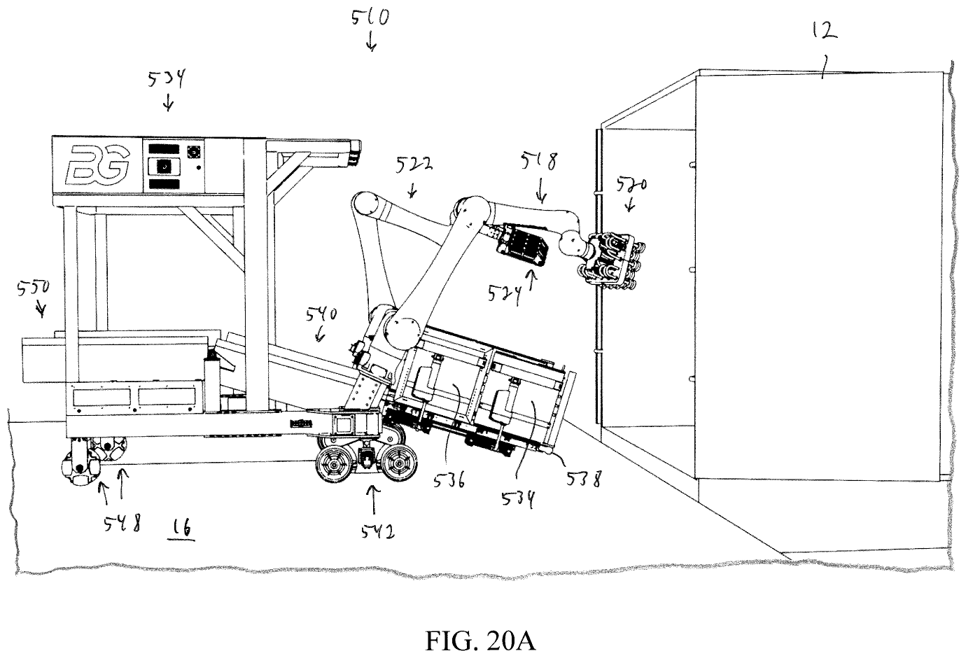

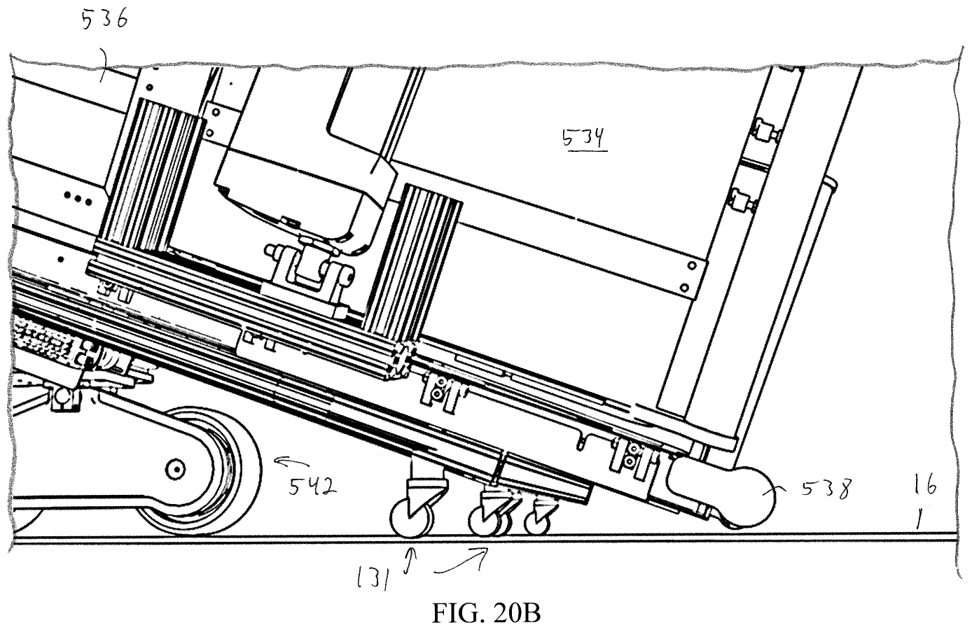

In accordance with further aspects the object processing system 110 may include a centered conveyance system on a mobile unit 125 as shown in FIG. 10. The centered conveyance system includes a loading conveyor system 130 that includes three portions (a central portion 132 and two wing portions 134, 136, as shown in FIGS. 11A and 11B). Again, the loading conveyor 130 may be formed of a belt conveyor material that readily engages objects. The loading conveyor 130 may further be provided on a frame that is cantilevered at its lower end over the trailer floor such that it travels over and slightly above the trailer floor. In accordance with further aspects, the loading conveyor 130 may include small guide wheels at ends of the leading edge of the loading conveyor 130 that cause it to travel over and slightly above the trailer floor (as shown for example at 131 in FIG. 20B).

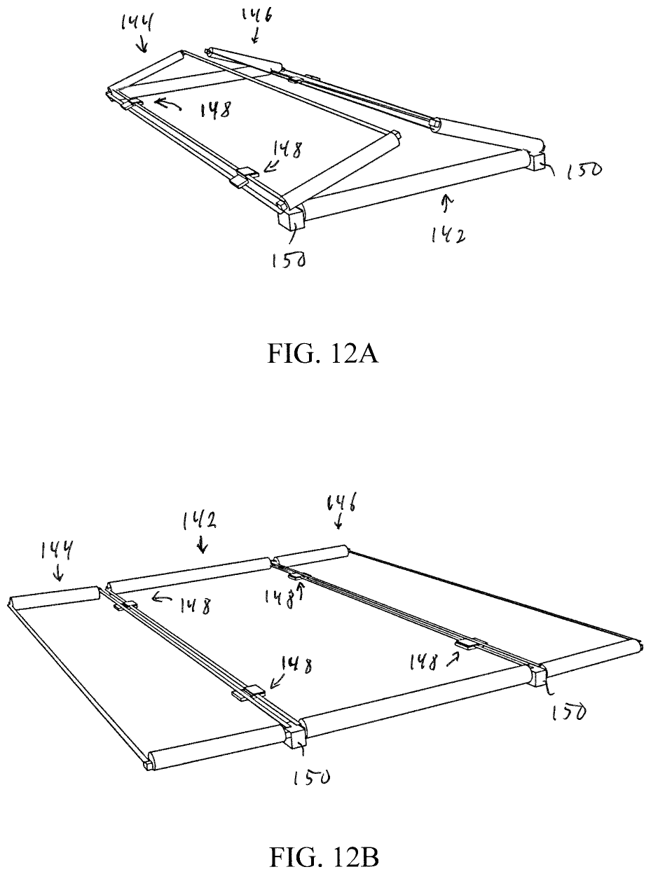

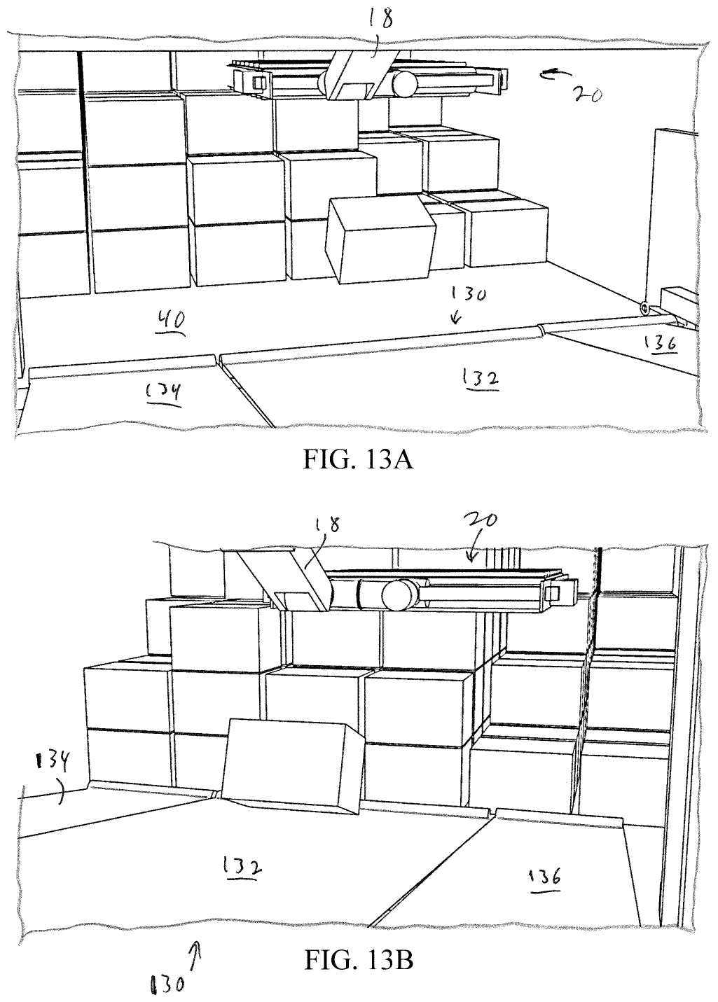

As shown in FIG. 10 the loading conveyor 130 is partitioned into portions that may be folded prior to entering the trailer 12. FIG. 11A shows the portions 132, 134, 136 folded while entering the trailer, and FIG. 11B shows the portions 132, 134, 136 unfolded to about the width of the trailer after entering the trailer. FIG. 12A shows frames 142, 144, 146 for the conveyor sections (132, 134, 136) when in the folded position. As also shown in FIG. 12A, the section 144 includes actuators 148 for unfolding the portions 144, 146 from the frame 142. FIG. 12B shows the frames 142, 144, 146 in the unfolded position. Power for controlling movement of the conveyors 132, 134, 136 is provided by motors 150 with which the proximal rollers become engaged when unfolded.

The mobile unit 125 (together with the programmable motion device 18 and the receiving conveyor 14 drawn behind it) may be moved into and out of the trailer 12 using one or more mobile unit motors 127. The system provides that as the mobile unit 125 moves into the trailer 12, the end-effector 20 engages objects in the trailer and urges them onto a conveyance system. The end-effector may be positioned at various orientations and poses as discussed above to best access the objects using perception data (e.g., images, 2D or 3D scan data) from the perception units 36. For example, objects may be processed that are closest to the structure 34 and that are highest off of the floor of the trailer.

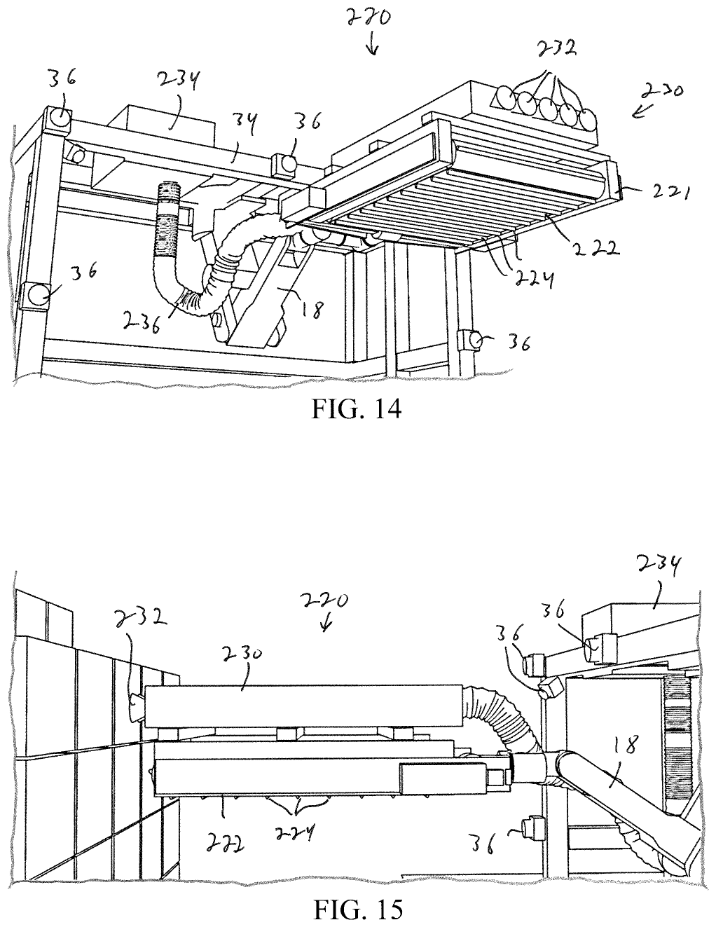

The dislodged objects in accordance with various aspects of the present invention including those described above and herein, may cause objects to fall onto a floor of trailer 40 as shown in FIG. 13A or onto a collection conveyor 130 as shown in FIG. 13B. The objects may also fall onto other objects (either previously dislodged or otherwise resting on the floor). In any event, the collection of objects by the collection conveyor 30, 130 is facilitated by the objects having become dislodged and dropped to a lower elevation.

In accordance with further aspects, end-effectors in certain applications may further include a secondary tool for facilitating handling obstructions. For example, FIG. 14 shows an end-effector 220 that includes a conveyor frame 221 and conveyor 222 mounted on a distal end of the programmable motion device 18 as discussed above. The programmable motion device 18 is mounted in structure 34 with perception units 36, and the structure 34 is attached to a mobile unit as also discussed above. The end-effector 220 also includes a secondary tool 230 attached to one side of the conveyor frame 221. The end-effector 220 does not enjoy the flexibility of dual-side use but does include additional functionality. The end-effector 220 includes a secondary tool 230 that selectively provides vacuum force at the end-effector 220. The tool 230 includes one or more vacuum cups 232 that are coupled to a vacuum source 234 via a vacuum hose 236. With reference to FIG. 15, the vacuum cup(s) 232 may be positioned by the programmable motion device 18 to contact one or more objects to facilitate removal.

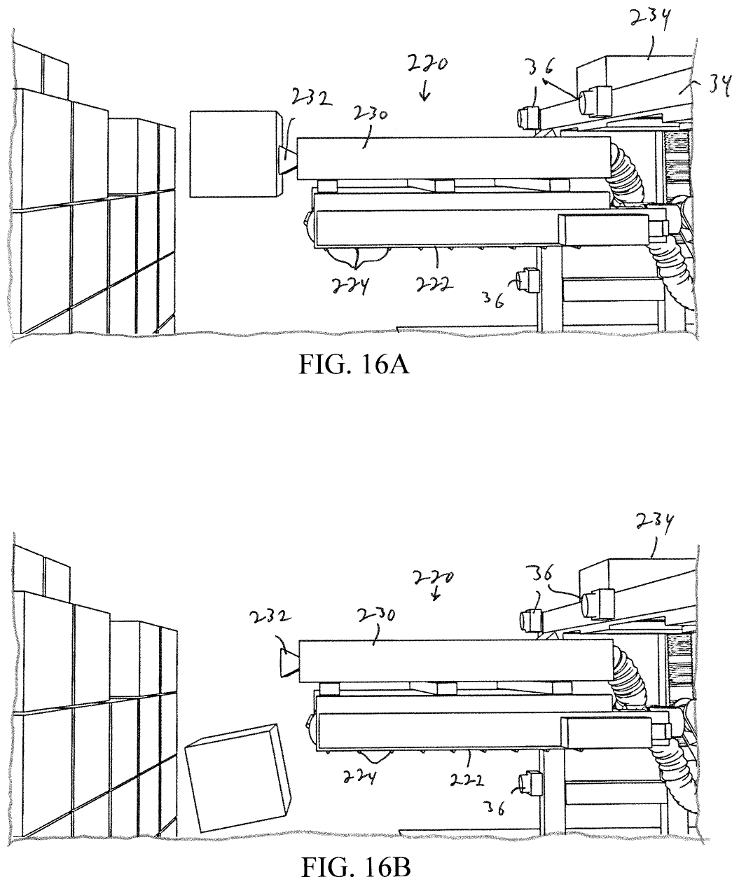

With further reference to FIGS. 16A and 16B, when the vacuum cup(s) 232 are engaged to grasp an object (e.g., an object that is heavy or determined to present an obstruction), the end-effector with the grasped object is drawn toward the structure 34 (as shown in FIG. 16A) and the vacuum to the vacuum cup(s) 232 from the vacuum source 234 is then turned off causing the object to fall (as shown in FIG. 16B). In this way, objects may be selectively removed by the secondary tool as required during processing.

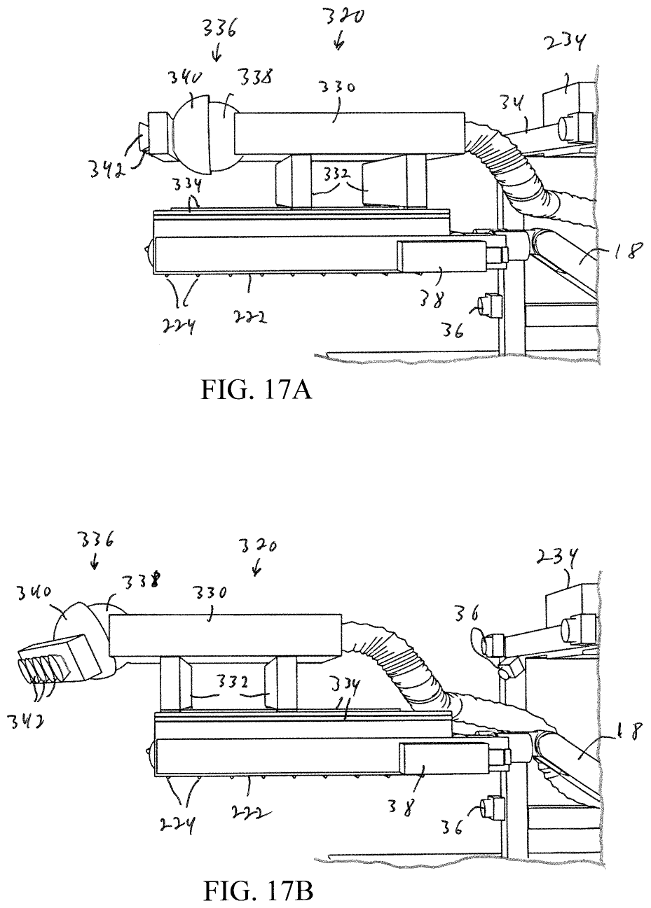

In accordance with further aspects, the vacuum application system may include an adaptive head that adapts to any surface that the vacuum cups contact as shown in FIGS. 17A and 17B. In particular, an end-effector 320 may include a tool 330 that is mounted to a conveyor frame 221 via a sliding mechanism 334 on which tool mounts 332 are provided as shown in FIG. 17A. When needed, the tool mounts 332 move along the sliding mechanism 334, and the vacuum cups 342 are free to contact one or more surfaces. The vacuum cups 342 are mounted to a pivot head 340 that is able to move with respect to a base 338 in multiple degrees of freedom. The flexible head 336 therefore may adjust to the surface contacted by the vacuum heads by rotating in two degrees of freedom as shown in FIG. 17B. In this embodiment the use of high flow vacuum supplied to the vacuum cups 342 from blower 434 can be advantageous in order to establish a faster, more stable grip, thereby minimizing a dwell time compared to low flow (and higher vacuum force) systems.

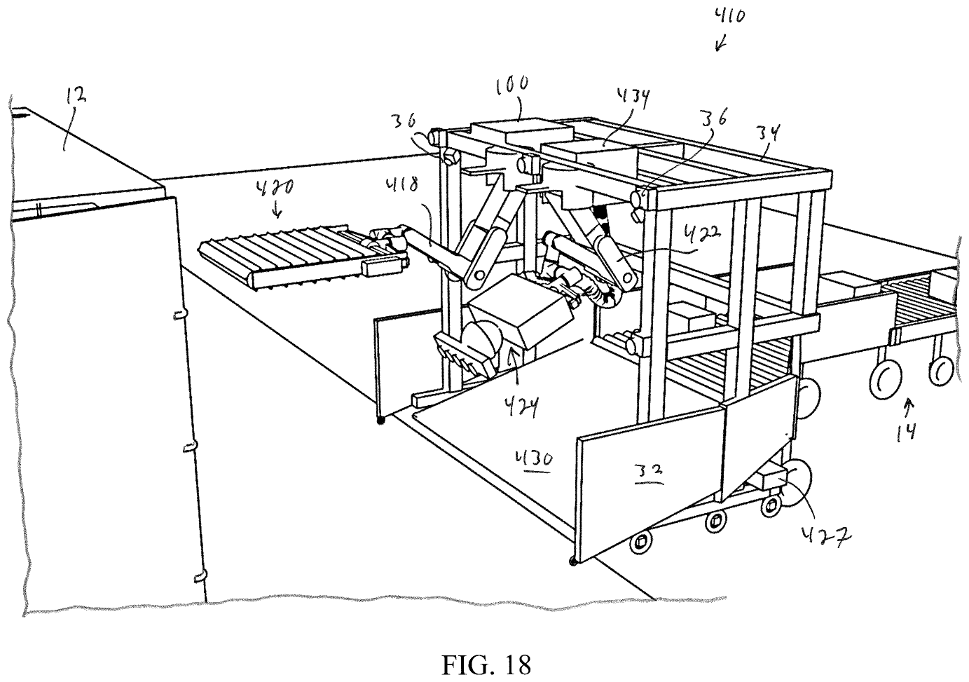

In accordance with further aspects, the system may include a plurality of programmable motion devices. For example, FIG. 18 shows an object processing system 410 that includes a structure 34 that includes two programmable motion devices 418, 422. Both programmable motion devices may include the same type of end-effector (e.g., two end-effectors 20 as discussed above) or may include different types of end-effectors. As shown in FIG. 18, the programmable motion device 418 includes an end-effector 420 similar to the end-effector 20 discussed above with reference to FIGS. 1-9D. The programmable motion device 422 includes an end-effector 424 similar to the tool 320 that includes the flexible head 336 of FIGS. 17A and 17B coupled to a high flow vacuum source 434. During use, the system 410 operates under the control of one or more computer processing systems 100 that communicate with the programmable motion devices 418, 422, the end-effectors 420, 424, the perception units 36, the mobile unit motors 427 and actuators, and the conveyance systems (e.g., 430) to provide that as the mobile unit moves into the trailer, the end-effectors engage objects as needed in the trailer and urge them onto the conveyance system. The end-effectors may be positioned at various orientations and poses as discussed above to best access the objects using perception data (e.g., images, 2D or 3D scan data) from the perception units 36.

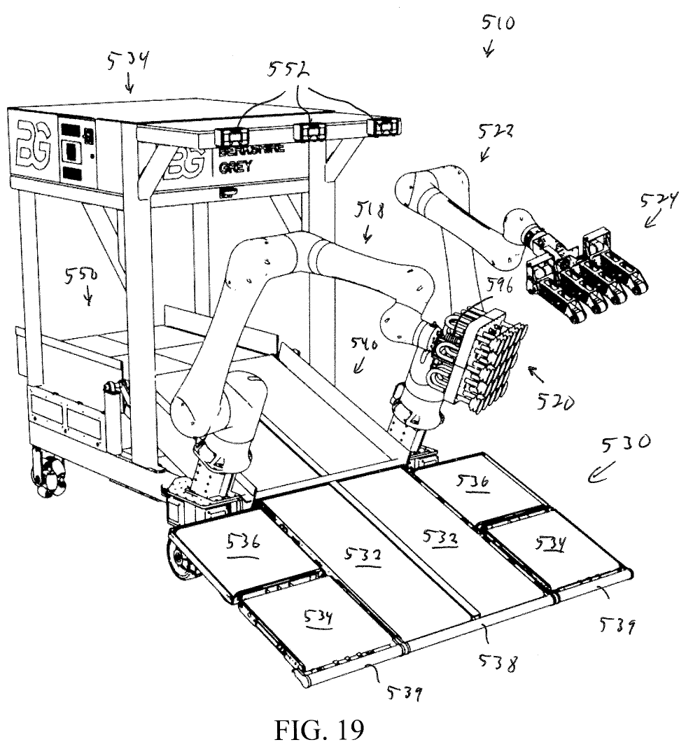

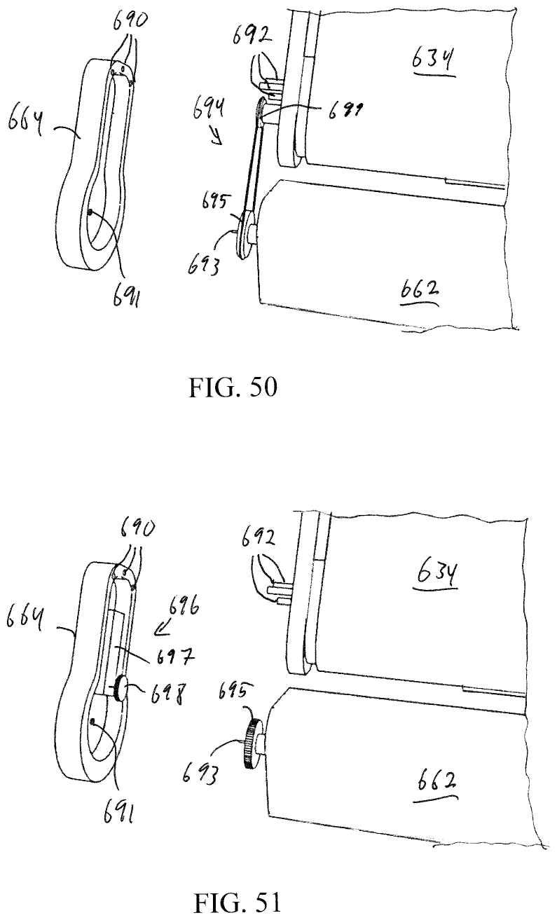

In accordance with still further aspects, the system may include a plurality of programmable motion devices and one or more kicker rollers. For example, FIG. 19 shows an object processing system 510 that includes a structure 534 that includes two programmable motion devices 518, 522 as well as one or more computer processing system (such as computer processing system 100 shown in FIG. 1) and a high flow vacuum source (e.g., the high flow vacuum source 434 shown in FIG. 18). Both programmable motion devices may include the same type of end-effector (e.g., two end-effectors 20 as discussed above) or may include different types of end-effectors. As shown in FIG. 19, the programmable motion device 518 includes an end-effector 520 with an array of vacuum cups, and the programmable motion device 522 includes an end-effector 524 with a series of actuating conveyor sections. Each of the programmable motion devices 518, 522 may move their respective end-effector about the space within the trailer to reach objects within the trailer and dislodge them onto either the trailer floor or onto the loading conveyor section 530. The loading conveyor section 530 includes a plurality of conveyor sections 532, 534, 536, and the loading sections 532, 534 each include a lead kicker roller 538 and 539. The kicker rollers directly contact any objects on the trailer floor and facilitate moving objects on the floor onto the loading conveyor section 530. The conveyor sections 532, 534 provide movement toward a collecting conveyor 540, which leads to a transition conveyor 550 for coupling to a side conveyance system. The kicker rollers 538, 539 may each be differently or independently driven with respect to the conveyor sections 532, 534 as discussed below with reference to FIGS. 50 and 51. Perception systems 552 may also be employed to provide perception data regarding, for example, the proximity of a stack or pile of objects within the trailer.

FIG. 20A shows a side view of the object processing system 510 about to enter a trailer 12 of a tractor trailer. The conveyor sections 534, 536 may be lifted along their sides adjacent the conveyor sections 532 (shown in FIG. 19) to facilitate entering the trailer, and the loading conveyor section 530 may be slightly elevated to protect the kicker roller 538 as the system 510 enters the trailer 12. The system 510 further includes two front drive wheel systems 542 as well as two rear steering wheel systems 548. Although simple castors (passive wheels) could be used in accordance with certain aspects of the invention, the use of active rear steering wheels (e.g., 548) may facilitate maintaining alignment of the object processing system within the trailer. The respective elevations of the loading dock 16 and the floor 40 of the trailer may differ, and a small distance may separate the loading dock 16 and the floor 40. If a ramp or temporary threshold is provided bridging the loading dock and the floor, the two front drive wheel systems 542 may still facilitate moving the object processing system onto and over the ramp or temporary threshold. FIG. 20B shows an enlarged view of the underside of the system 510 showing support caster wheels 131 on the underside of the conveyor sections 532 (shown in FIG. 19).

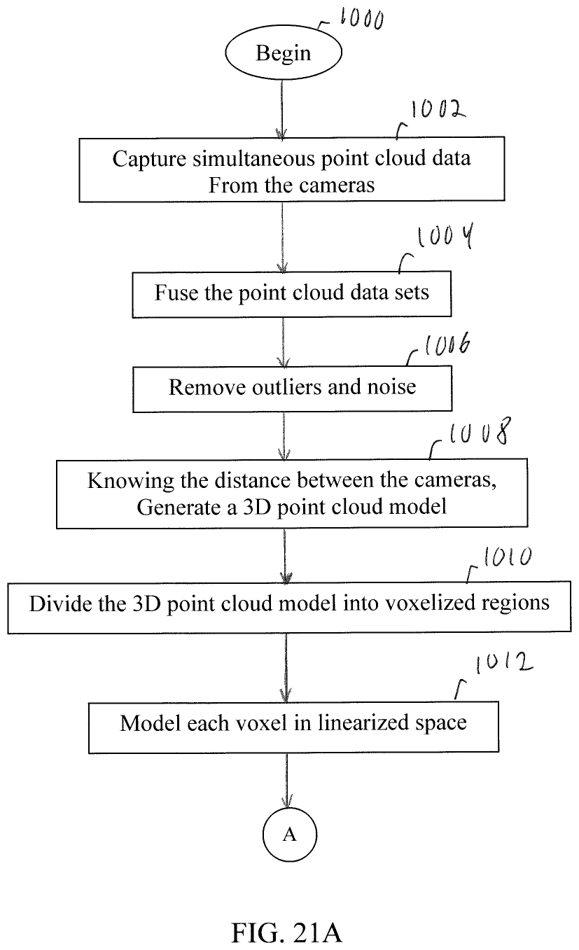

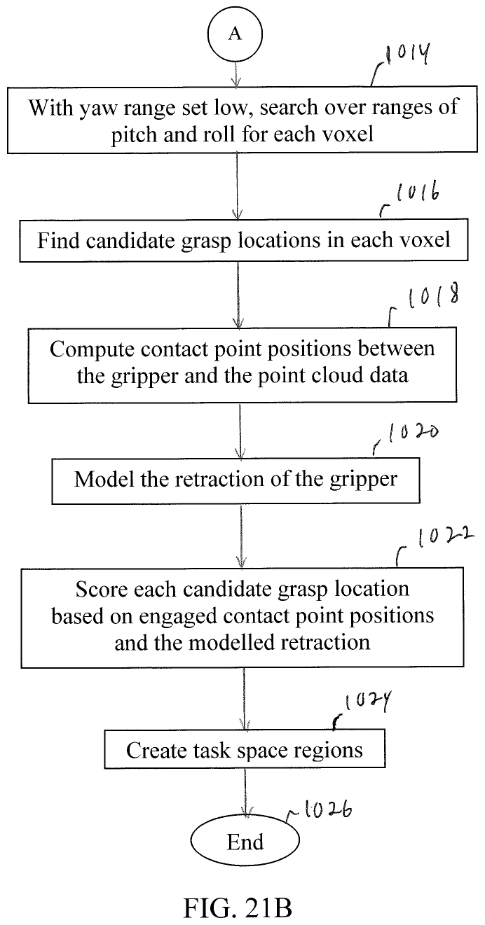

The object processing systems disclosed herein may employ a variety of perception systems and perception methodologies. For example and with reference to FIGS. 21A and 21B, the system may involve engaging a plurality (e.g., three) perception units 552 (e.g., machine vision smart cameras) mounted above the workspace of the programmable motion devices (shown in FIG. 19). Each of the perception units 552 may capture colorized point cloud data, and each of the perception units is calibrated and positioned at a known location and spacing. The use of two or more such perception units provides unique angles to show three-dimensional nature of the point cloud data. The process may begin (step 1000) by capturing simultaneous point cloud data using the perception units 552 (step 1002). The point cloud data sets are then fused (step 1004) and points outside of the region of interest are removed. The system then removes data associated with noise (radius and statistical outlier removal) (step 1006).

The system will then seek to maximize contact between edges of cups and objects by scoring candidate grasp locations. The system will also seek to prevent grasp locations that are too close together by only including a finite number of grasp locations within voxelized regions of the workspace. In particular, knowing the distance between the perception units 552, the system will generate a 3D point cloud model (step 1008) and then divide the 3D point cloud model into voxelized regions (step 1010). The system will then search linearized space, finding the best grasp locations in each voxel. In particular, the system will model each voxel in linearized space (step 1012) and then search over explicit ranges of pitch and roll (with a yaw range set low (e.g., to zero) (step 1014).

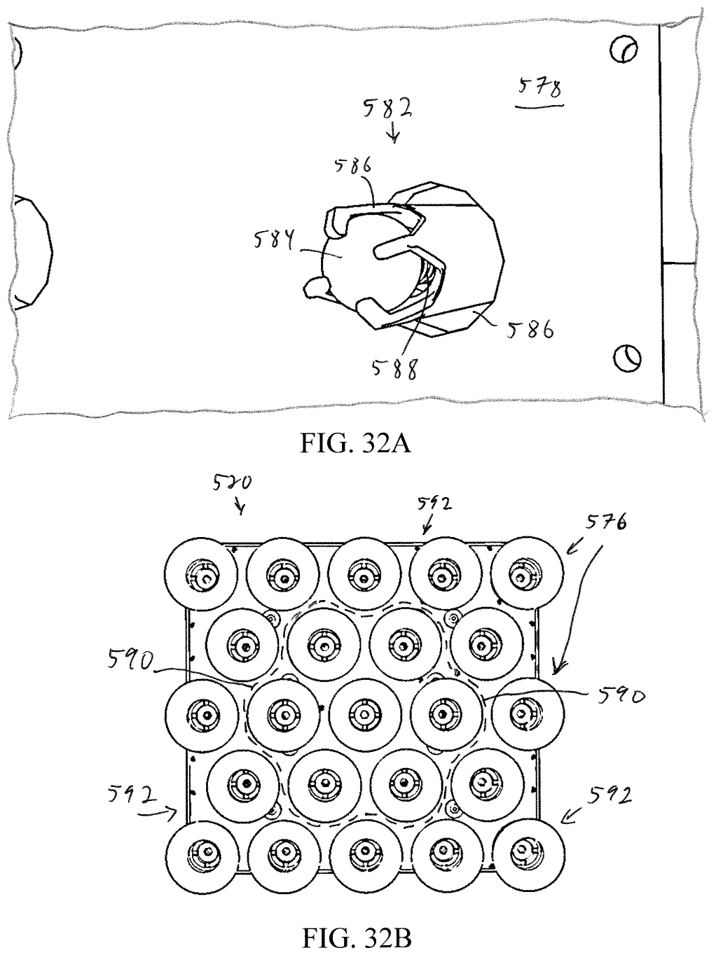

The system will then find candidate grasp locations in each voxel (step 1016) and then compute contact point positions between the gripper and the point cloud data (step 1018). The retraction of the gripper is then modelled (step 1020) omitting grasps where the gripper exits the region of interest and where the object is too close to an obstruction etc.). The system will then score each candidate grasp location based on engaged contact point positions and the modelled retraction of the gripper (step 1022). The system will then create task space regions (step 1024) prior to ending (step 1026) the iteration. With reference to FIG. 32B, the gripper may include an array of vacuum cups that are provided in two or more zones 590, 592. Each zone may be differently modelled in providing the modelled retraction of the gripper such that, for example, vacuum cups in the zone 590 may have a higher scoring value (e.g., 3 or 4) as compared to the vacuum cups in the zone 592 (e.g., 1 or 2). In this way, a portion (such as the center) of the vacuum cup array may be favored in developing grasp locations. The grasp locations may be pull locations on surfaces of objects that are facing the mobile system, and may be pick locations on exposed top surfaces of the objects.

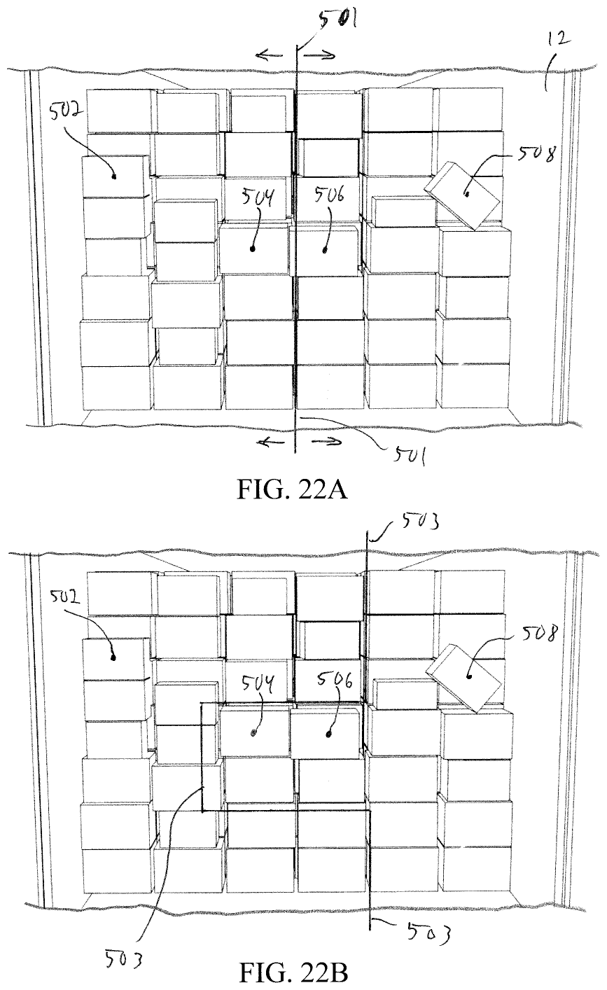

When the grasp (pull) locations (e.g., 502, 504, 506, 508) are determined, the system may apportion the full region of objects within the trailer 12 into partitioned regions as shown in FIGS. 22A and 22B where two end-effectors are used. In particular, FIG. 22A shows a partition 501 that is vertically uniform such that grasp locations 502 and 504 are in one region and grasp locations 506 and 508 are in the other region. The partition 501 may be varied as objects are being removed (for example, if more objects or heavier objects are on one side of the trailer). FIG. 22B shows a partition 503 that varies in the vertical direction such that grasp location 502 lies in one partitioned region while grasp locations 504, 506, 508 lie in the other partitioned region. Again, the partition 503 may be varied dynamically as objects are being removed for a variety of reasons such as weight of objects, volume of objects and the presence of an object that cannot be processed (an exception).

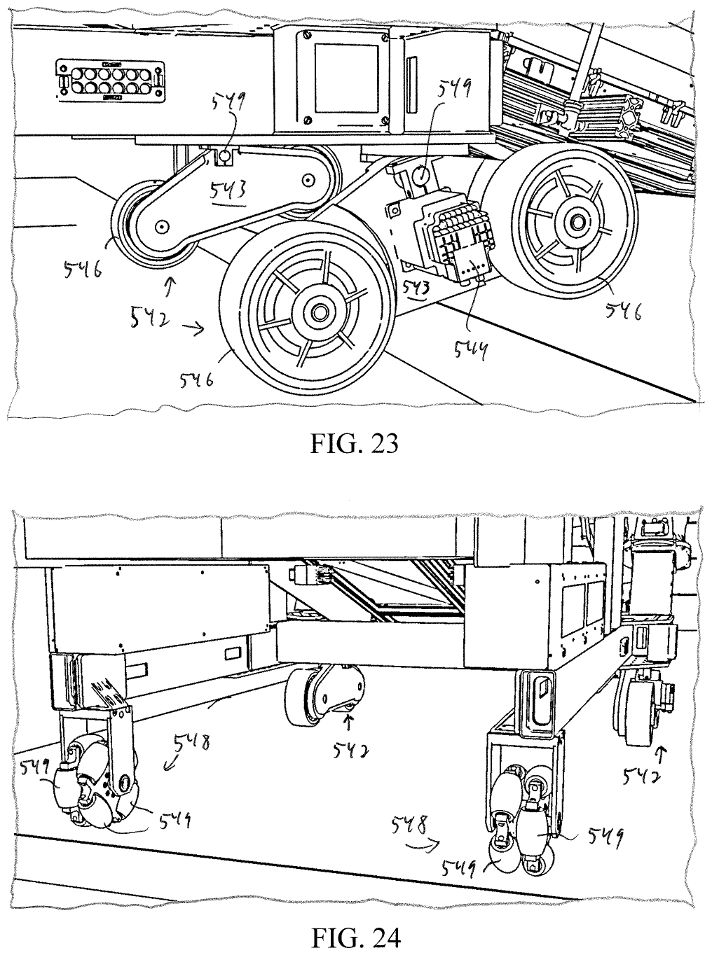

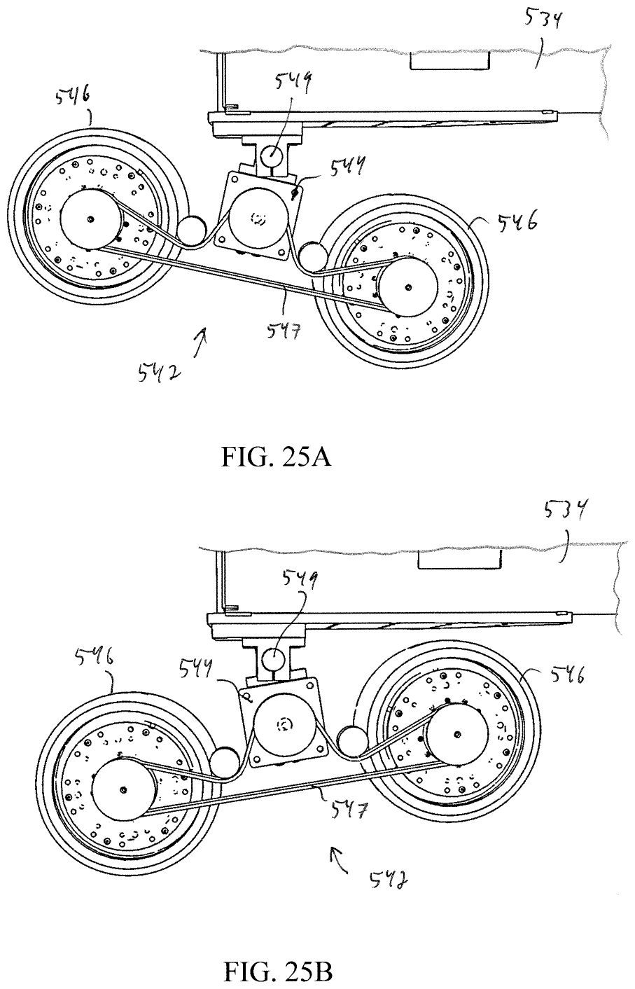

With further reference to FIG. 23, each front drive wheel system 542 includes a pivotable frame 543 that includes a motor 544 and two driven wheels 546. FIGS. 25A and 25B show a front drive wheel assembly (with the frame removed for clarity) showing each wheel 546 being drive via a belt 547 by the motor 544. The pivoting of the wheel system 542 about the pivot pin 549 is independent of the application of power to the wheels 546 by the motor 544. This permits each wheel system 542 to accommodate gaps and differences in elevations as the object processing system 510 enters and exits the trailer.

FIG. 24 shows the rear steering wheel systems 548 that may be powered, each of which includes activatable transverse rollers 549 permitting the wheel systems to actively steer the rear wheels as the system enters and moves within the trailer. Maintaining the unloading system equidistant between the inner side walls of the trailer may be important not only for efficiently gathering objects, but also for deployment of the conveyor sections 534 and 536 as well as to permit access by human personnel (by being rotated upward to permit access) as discussed herein. FIGS. 25A and 25B show that the front wheel systems 542 engage the drive motor 544 with the wheels 546 via the belt 547 regardless of a rotational position of the front wheel systems 542 with respect to the frame 534 via the pivoting mount 549. FIG. 25A shows a front wheel system with the wheel 546 under the frame pivoted downward under the frame 534 and FIG. 25B shows the front wheel system with the wheel 546 under the frame pivoted upward under the frame 534.

The object processing system 510 may remain aligned within the trailer by using multi-directional wheel systems 548 that provide rotation in the direction of the wheel system 542 as well as movement transverse to the direction of movement of wheel system 542 through actuation of cross-direction rollers 549. The steering provided by the multi-directional wheel systems 548 may be particularly helpful when exiting the trailer (in combination with the front wheel systems 542 moving in a reverse direction).

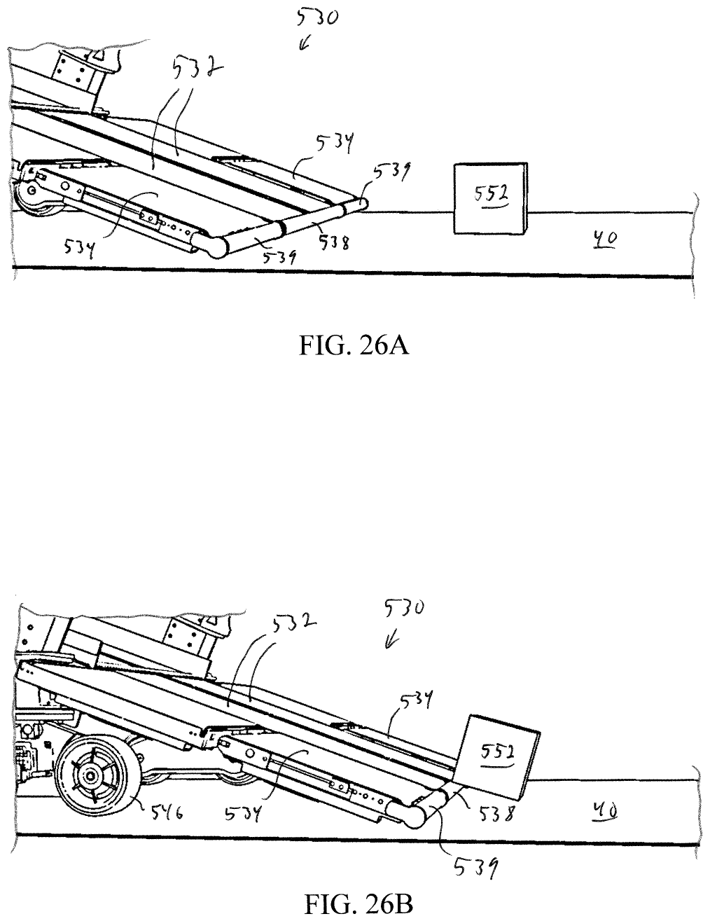

As discussed herein, objects may be deposited onto the loading conveyor section 530 or may be deposited onto (or already be on) the trailer floor 40. With reference to FIGS. 26A and 26B, an object may be contacted by a kicker roller 538 and/or 539 and kicked up onto the loading conveyor section 530. FIG. 26A shows an object 552 being approached by the loading conveyor section 530, and FIG. 26B shows the object 552 being lifted and moved onto the loading conveyor section 530 by the kicker roller 538.

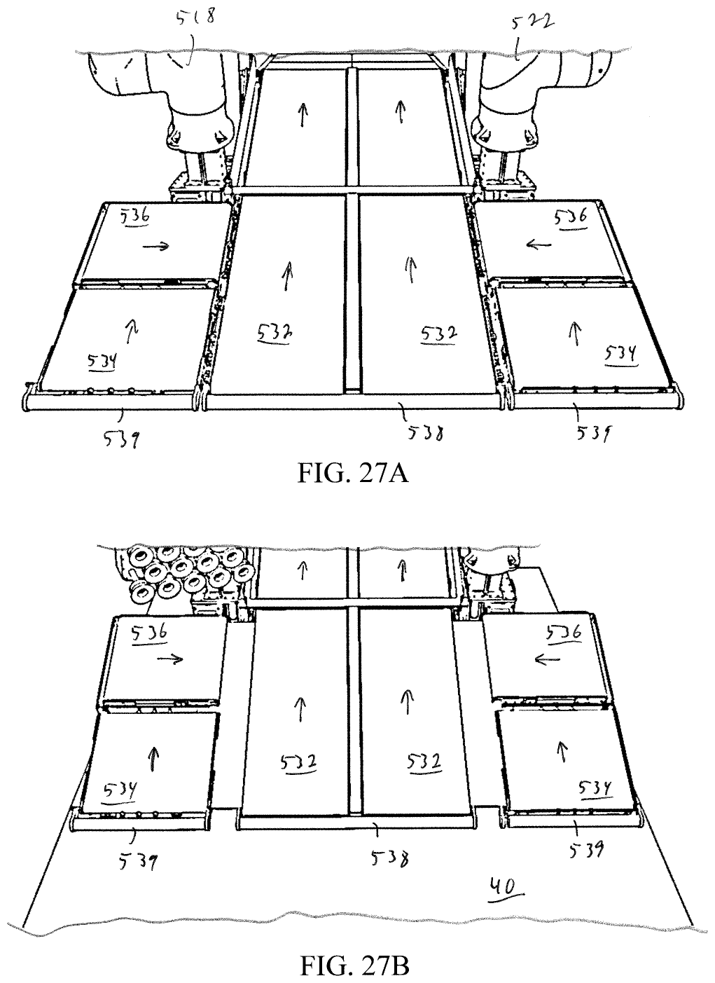

FIGS. 27A and 27B show the loading conveyor section 530 of FIGS. 26A and 26B including the kicker rollers 538, 539 and the conveyor sections 532, 534, 536 leading to the collection conveyor 540. FIG. 27A shows that the direction of movement of the conveyors of these sections provides that the conveyor sections 532, 534 move in the direction toward the collection conveyor 540, and the conveyor sections 536 move in a transverse direction toward each other from opposite sides of the loading conveyor section 530. With further reference to FIG. 27B, the loading conveyor section 530 may further include expansion mechanisms as shown in FIG. 27B for extending the conveyor sections 534, 536 away from the conveyor sections 532 so that the outer width of the loading conveyor section 530 approximates the width of the floor 40 within the trailer. The expansion mechanism can be adjustable with a leadscrew linkage between conveyor sections 534 and 536 and the supporting frame of conveyor section 530 and either manually operated or actuated with an electrical motor drive module. A flexible bellows can be provided to prevent small objects from falling between the conveyor sections 534 and 536 when expanded.

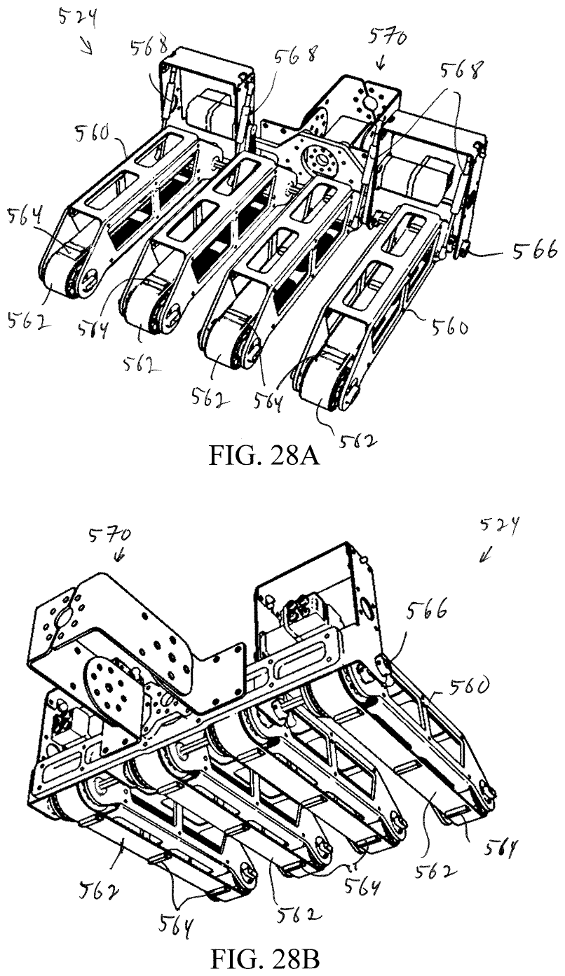

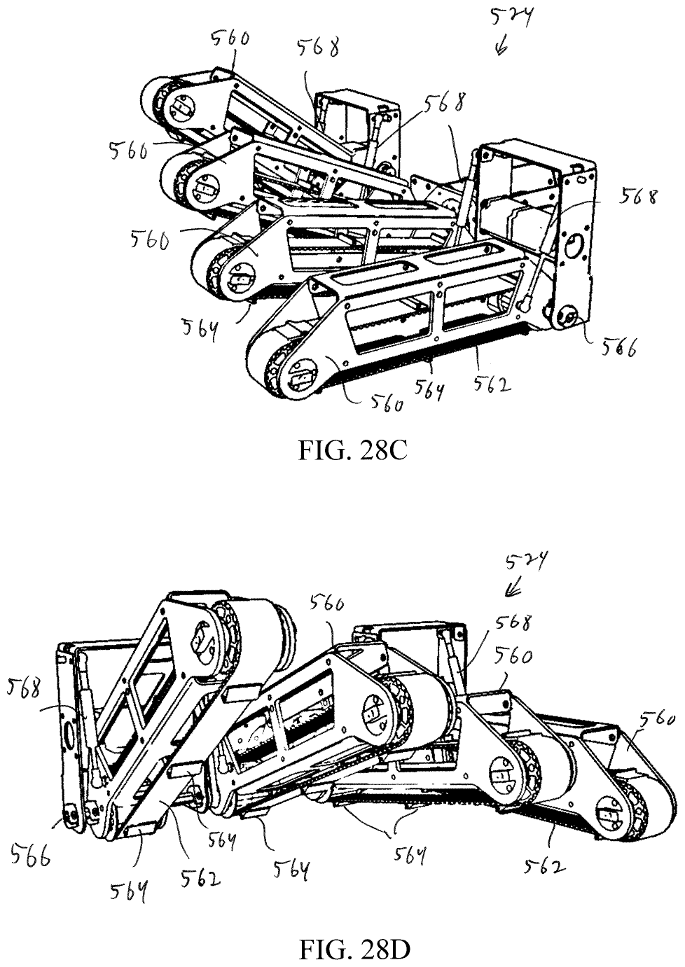

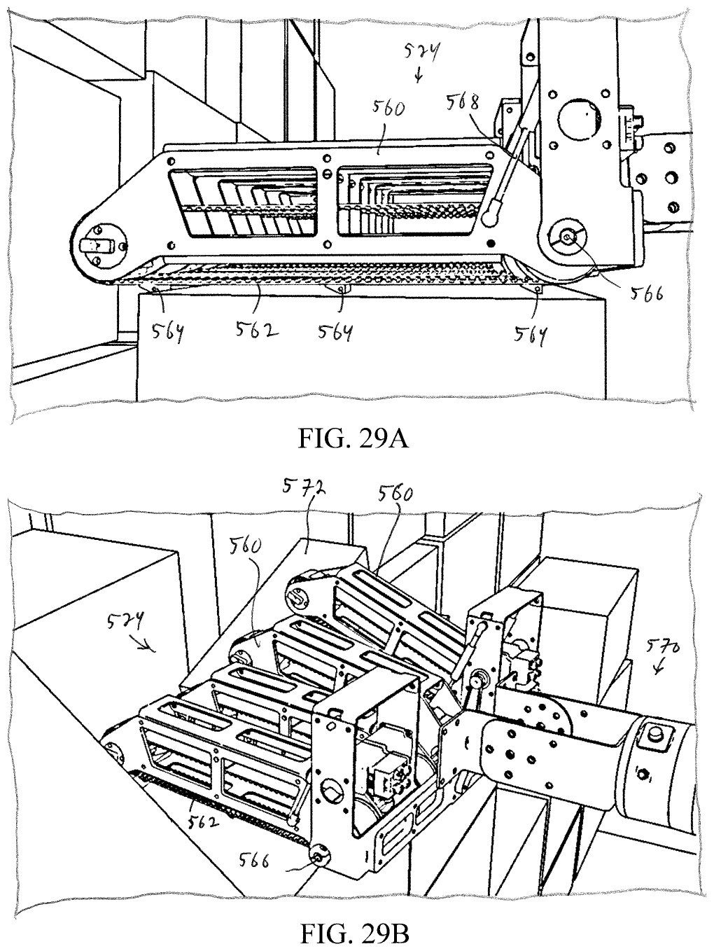

The end-effector 524 on the programmable motion device 522 includes a plurality of narrow conveyor sections that are mounted on individually articulated finger units. With reference to FIG. 28A each finger unit 560 includes a powered conveyor 562 with cleats or engagement features 564 for engaging objects. Each of the finger units 560 is provided as a frame that may be actively pivoted about an axis 566 using any of a plurality of actuators 568 to individually rotate each finger unit with respect to the axis 566. FIG. 28A shows an elevated view of the distal end of the end-effector and FIG. 28B shows an underside view of the proximal end of the end-effector showing the coupling hardware 570 for coupling to the programmable motion device 522. FIG. 28C shows a front left view of the end-effector with each of the finger units rotated a different amount, and FIG. 28D shows a front right view of the end-effector of FIG. 28C.

FIG. 29A shows the end-effector 524 engaging an object 572 with the cleats or features 564 of the narrow conveyor belts 562 as the belts move away from the coupling hardware on the top and toward the coupling hardware on the bottom. The end-effector 524 may be rotated upward or downward as discussed above with reference to the end-effector 20 of FIGS. 3A and 3B or rolled from one side to another as discussed above with reference to FIGS. 4A and 4B. Additionally, each of the finger units 560 may be individually rotated with respect to the axis 566, and this actuation may be passive or active using the actuators 568 to permit the end-effector to most effectively engage the objects. For example, FIG. 29B shows two of the finger units rotated by different amounts to engage an irregular pile of objects within the trailer.

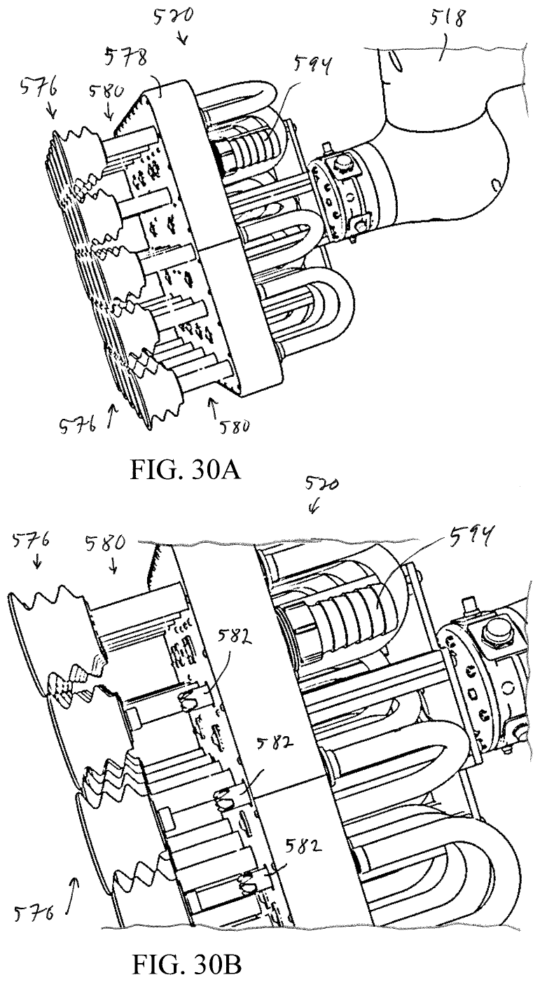

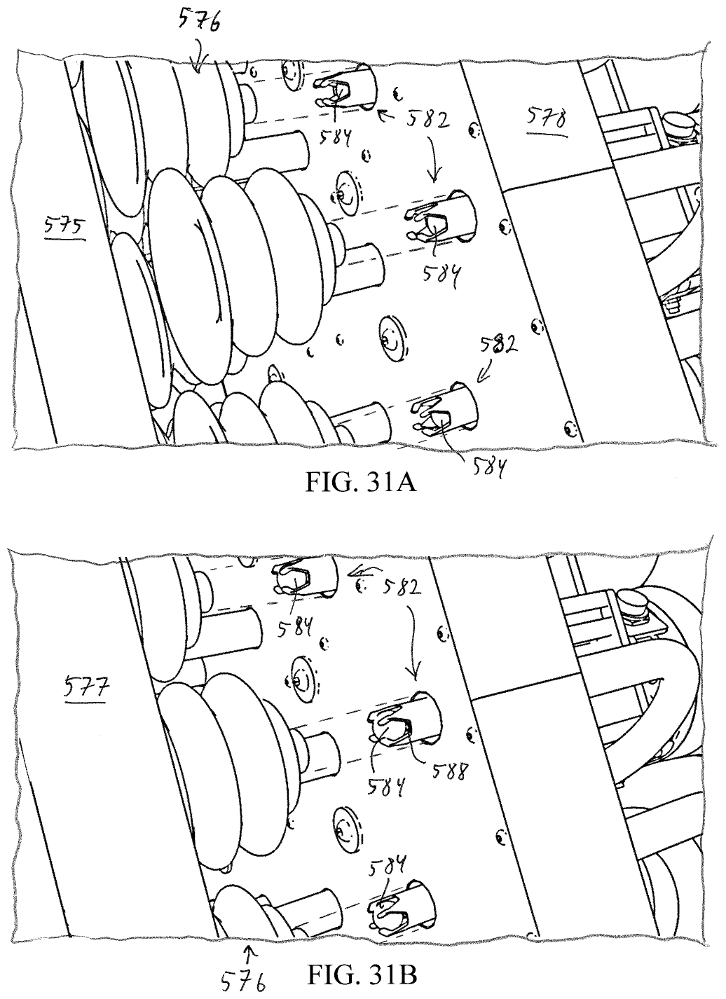

FIG. 30A shows an enlarged view of the end-effector 520 showing an array of vacuum cups 576 that are mounted to manifold 578 via conduits 580. With further reference to FIG. 30B, each conduit includes a check valve assembly 582 (three of which are shown by omitting each respective conduit). Each check valve assembly 582 within each conduit 580 is normally open to provide vacuum pressure (through the corresponding vacuum cup) when the vacuum cup is sufficiently engaged with an object but, in certain situations, closes off vacuum when an object is not engaged. For example, each check valve assembly 582 includes a movable valve ball 584 that is shown in FIG. 31A in a position to close off each respective vacuum line. When the vacuum cups 576 engage an object 577 as shown in FIG. 31B, each movable valve ball 584 associated with each applied vacuum cup moves outward with respect to the manifold 578 to permit the vacuum to flow through the respective vacuum cups 576.

FIG. 32A shows an enlarged view of a check valve assembly 582, showing the movable valve ball 584 within a retention cage 586. Each check valve assembly 582 may also include a biasing spring to bias the valve ball 584 in an outward position permitting vacuum flow. This permits the vacuum to flow even if the seal of the vacuum cup with an object (e.g., 577) does not produce a tight seal. For example, a high flow vacuum source (such as a blower) may be used that provides at each vacuum cup of, a vacuum with an airflow of at least about 100 cubic feet per minute, and a vacuum pressure at each vacuum cup of no more than about 65,000 Pascals below atmospheric (e.g., about 50,000 Pascals below atmospheric or 7.25 psi). The use of the check valves with the array of vacuum cups permits the vacuum to be applied only through the vacuum cups that are making sufficient contact with an object to be unloaded with the trailer.

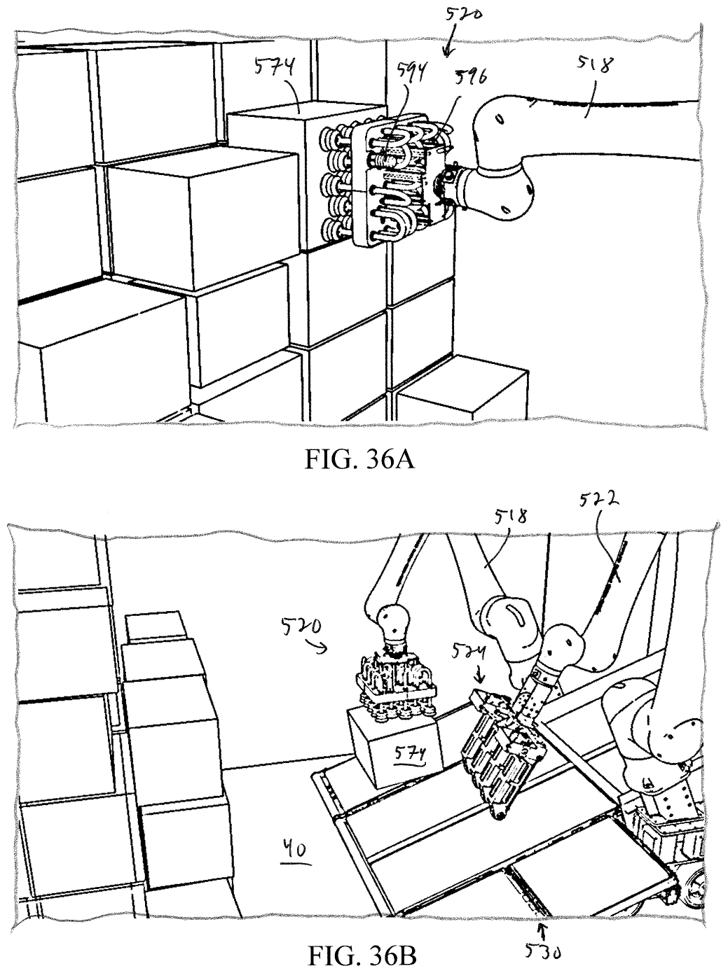

Additionally, the array of vacuum cups 576 may be connected to the vacuum source (or plural vacuum sources) through independently controllable zones. FIG. 32B shows a central zone 590 as well as a more peripheral zone 592 (the vacuum cups outside the central zone 590). Each zone may be separately coupled to one of plural vacuum sources via connectors 594, 596 shown in FIG. 36A and may therefore provide different levels of vacuum and/or flow. The spring contact of each valve spring 588 may be chosen to provide vacuum at each vacuum cup when a drop in the pressure due to engagement or contact or proximity to an object is sufficient for moving objects. A high vacuum flow may be suitable for moving objects that cannot provide a tight seal with any vacuum cups while quickly establishing a stable grip of the object despite an imperfect seal.

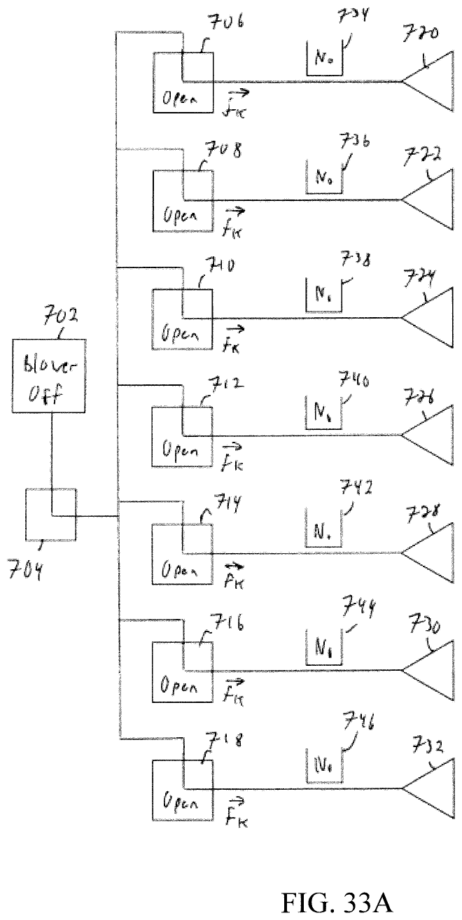

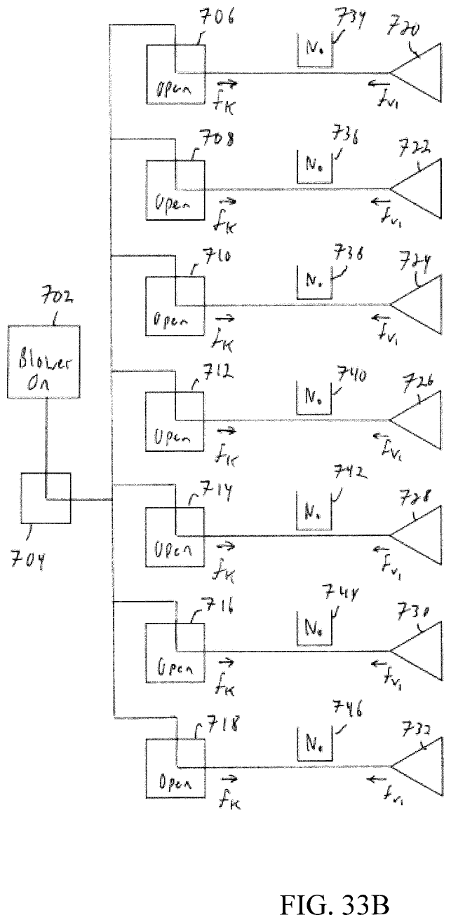

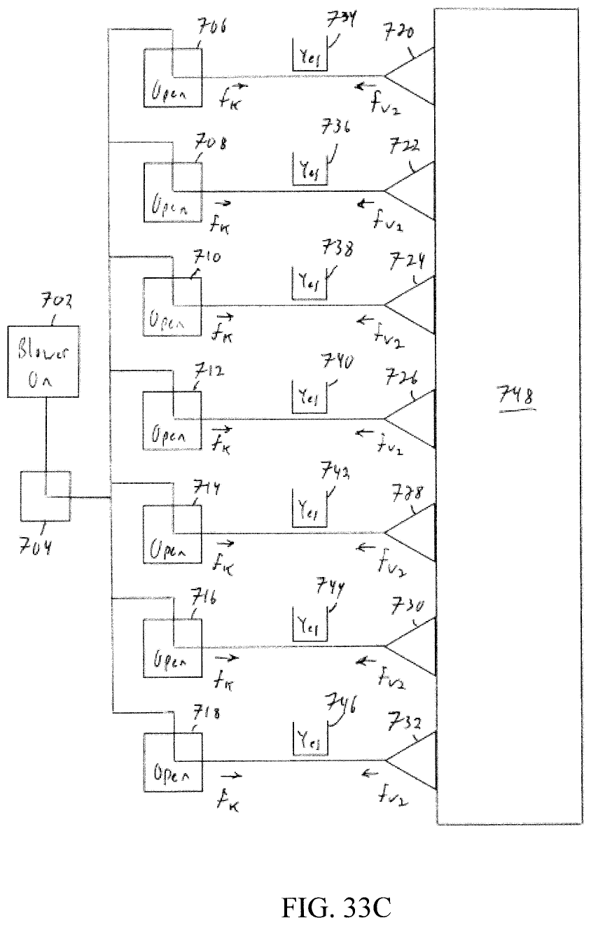

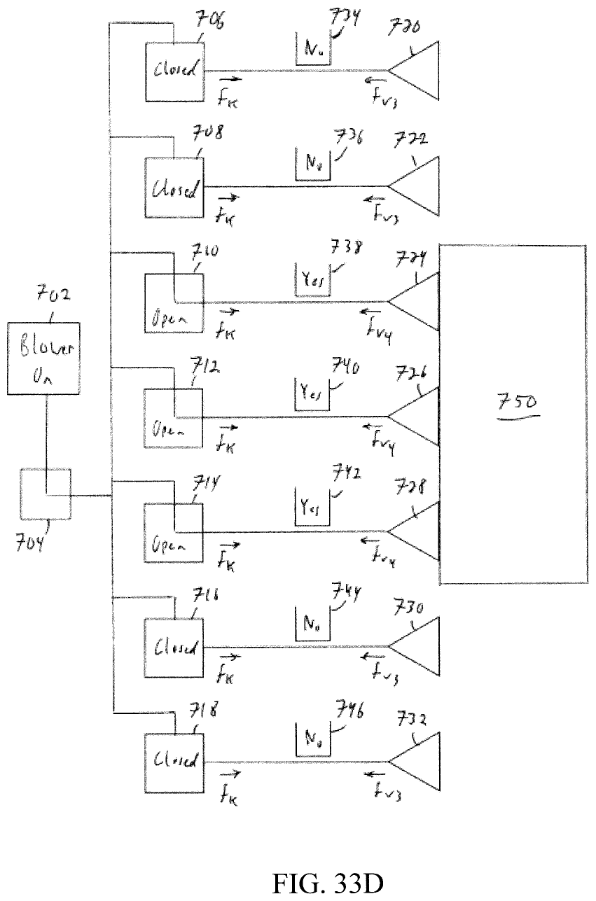

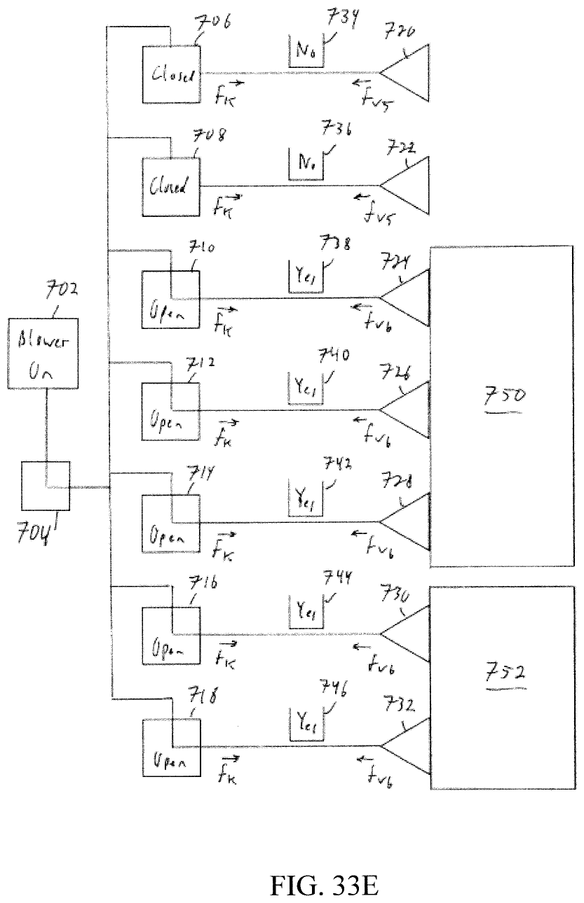

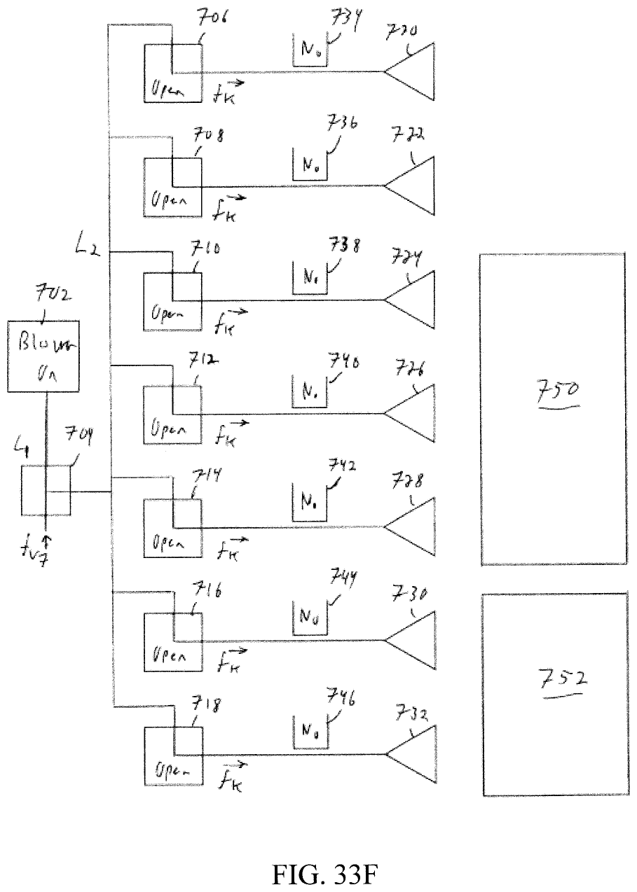

The high flow vacuum is provided to be on as the vacuum cups approach an object to be grasped. If some vacuum cups engage an object but others in a zone do not, the other vacuum cups will have their valves close off, providing further vacuum force to the engaged cups. This done automatically though the selection of the valve spring, the valve spring constant and any preloading as discussed herein. In particular, FIG. 33A shows a functional diagram of the zone 590 (shown in FIG. 32B) that includes seven valve assemblies. When the blower 702 is off, each valve (706-718) is open because the force of the spring (588 in FIG. 32A) is pushing the ball 584 to the open position. No vacuum is provided at the vacuum cups 720-732 because the blower 702 is off. The object detection sensors 734-746 register that no object is attached to any vacuum cup. With reference to FIG. 33B, when the blower 702 is turned on, vacuum flows from the blower valve 704 and in turn through each of the valves 706-718 from the vacuum cups 720-732. The valves 706-718 are each held open because the force of the spring (fₖ) is greater than the opposing force (fᵥ₁) generated by the flow of air due to the vacuum flowing through all seven vacuum cups 720-732. The spring 588 is selected and employed to provide that the valves will stay open under the force (fᵥ₁) of the vacuum flowing through all cups. Again, the sensors 734-746 register that no object is attached to any vacuum cup.

With reference to FIG. 33C, when all vacuum cups 720-732 engage an object 748 the flow of air due to the vacuum through the vacuum cups 720-732 is greatly reduced, causing the valves 706-718 to remain open. The sensors 734-746 will register that an object is engaged by their associated vacuum cups because the pressure in each respective vacuum conduit will be within a designed vacuum window (between full vacuum and atmosphere). The object 748 is discharged by actuation of the blower valve 704 as discussed below with reference to FIG. 33F.

When some but not all vacuum cups of a zone (e.g., 590) engage an object such as object 750 in FIG. 33D, then the force (fᵥ₄) of the flow of air due to the vacuum at the engaged vacuum cups 724, 726, 728 is greatly reduced as discussed above. In this case however, the force (fᵥ₃) due to the vacuum flow through the cups 720, 722, 730, 732 is increased because three of the cups are nearly blocked (cups 724, 726, 738). The force fᵥ₃ is greater than the force fᵥ₁ and significantly is greater than the force of the spring constant fₖ. This causes the valves 706, 708, 716, 718 to close, which increases the vacuum force applied to the object 750 by the engaged cups 724, 726, 728 so that fᵥ₄>fᵥ₂. The sensors 738, 740, 742 will register that an object is engaged by their associated vacuum cups because the pressure in each respective vacuum conduit will be within a designed vacuum window (between full vacuum and atmosphere). Conversely, sensors 734, 736, 744, and 746 will register that an object is not engaged since the pressure in each respective vacuum conduit will be approximately at atmospheric pressure. Note that in FIG. 31A, an object 575 is being held by the gripper but the vacuum cups associated with the valves shown do not engage the object 575, whereas in FIG. 32B, the vacuum cups associated with the valves shown do engage the object 577.

If a further object 752 is similarly engaged by vacuum cups 730, 732 along with object 750 by vacuum cups 724, 726 and 728 as shown in FIG. 33E, then valves 710, 712, 714, 716, and 718 will remain open because the force of the vacuum flow fᵥ₆ at the vacuum cups 730, 732 will be reduced and fall below the force of the spring (fₖ). The forces at the vacuum cups 724, 726, 728 will also be reduced from fᵥ₄ to fᵥ₆ but will still be much lower than the force of the spring (fₖ). The force (fᵥ₃) due to the vacuum flow through the cups 720 and 722 is increased because all of the cups are nearly blocked (cups 724, 726, 728, 730, and 732). The force fᵥ₅ is greater the force of the spring constant fₖ. This causes the valves 706 and 708 to close, which increases the vacuum force applied to the objects 750 and 752 by the engaged cups 724, 726, 728, 730, and 732. The sensors 738-746 will register that an object is (or one or more objects are) engaged by their associated vacuum cups because the pressure each the respective vacuum conduit will be within a designed vacuum window (between full vacuum and atmosphere).

Any object or objects engaged by one or more vacuum cups may be discharged through actuation of the blower valve 704. In particular, the valve 704 may open both the blower and the line to the valves 706 to atmosphere. Because the distance from the blower 702 to atmosphere (shown diagrammatically as L₁) is much shorter than an average distance through the valves 706-718 to the cups 720-732 (shown diagrammatically as L₂), the blower vacuum is maintained by drawing through the valve 704. The design of the system takes advantage of positioning the blower valve 704 very close to the blower 702.

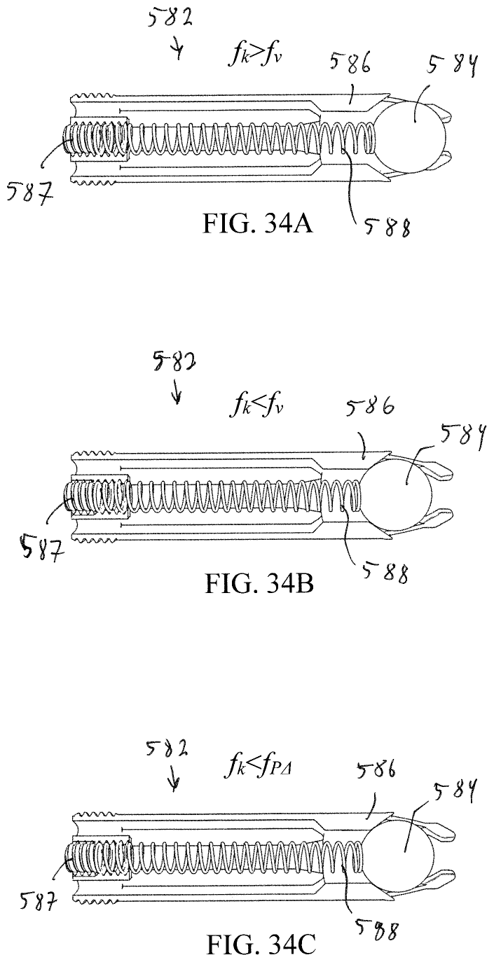

FIGS. 34A-34C show states of each valve assembly during use. FIG. 34A shows the valve assembly in the open position with the spring 588 pushing the ball 584 full against the outer claws of the retention cage 586. In this situation the force fₖ is greater than any opposing force (fᵥ) applied to the ball through associated vacuum cup (fₖ>fᵥ). With reference to FIG. 34B, if the force fᵥ proportional to the resistance of the air flow passing over the ball 584 becomes greater than the force fₖ, (e.g., if some other vacuum cups are engaged but not the one associated with this valve which results in significantly more airflow through vacuum cups that are not engaged with an object), then the valve closes. Once closed, the airflow effectively stops but pressure in the valve conduit (and all vacuum cups engaged to an object) will become very reduced due to the vacuum, and the pressure differential (f_{PΔ}) between the pressure within the valve conduit and atmosphere (on the other side of the ball) will keep the valve closed as shown in FIG. 34C.

The system may be designed to require a minimum number of vacuum cups to engage an object by selection and design of the spring knowing the operational forces under different vacuums. This minimum number may be, for example, one, two, three or four cups, and the tuning of the relationship may be achieved by varying the spring constant (switching our different springs) or by varying the preload on the springs. For example, the preloading on the spring 588 in FIGS. 34A-34C may be adjusted by adjusting (turning) the preloading plug 587.

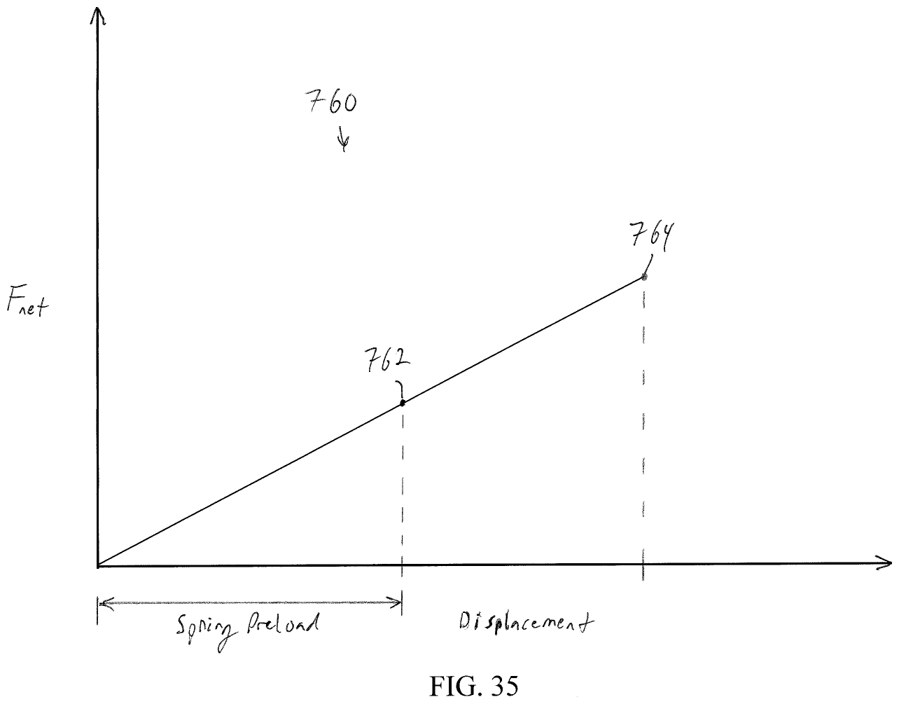

FIG. 35 shows at 760 these relationships, showing spring displacement verses the net force of the system in the direction of the spring force. The net force is fₖ−(fᵥ+f_{PΔ}). The graph shows the valve closed at 762 and shows the valve open at 764, and the system operates within this range providing that different vacuum forces are greater than the force of the spring while others are less than the force of the spring as discussed above. When the forces acting against the spring force fₖ are minimal, the valve is open as shown at 764. Adjusting the spring preload adjusts the force needed to close the valve.

The end-effector 520 of the programmable motion device 518 therefore includes a plurality of vacuum cups 576 for engaging objects (e.g., object 574) as show in FIG. 36A, and for moving the objects to either the floor 40 of the trailer or to the loading conveyor section 530 as shown in FIG. 36B. In accordance with various further aspects, system of the invention may employ two programmable motion devices with the same type of end-effector (e.g., both end-effector 520 or both end-effector 524).

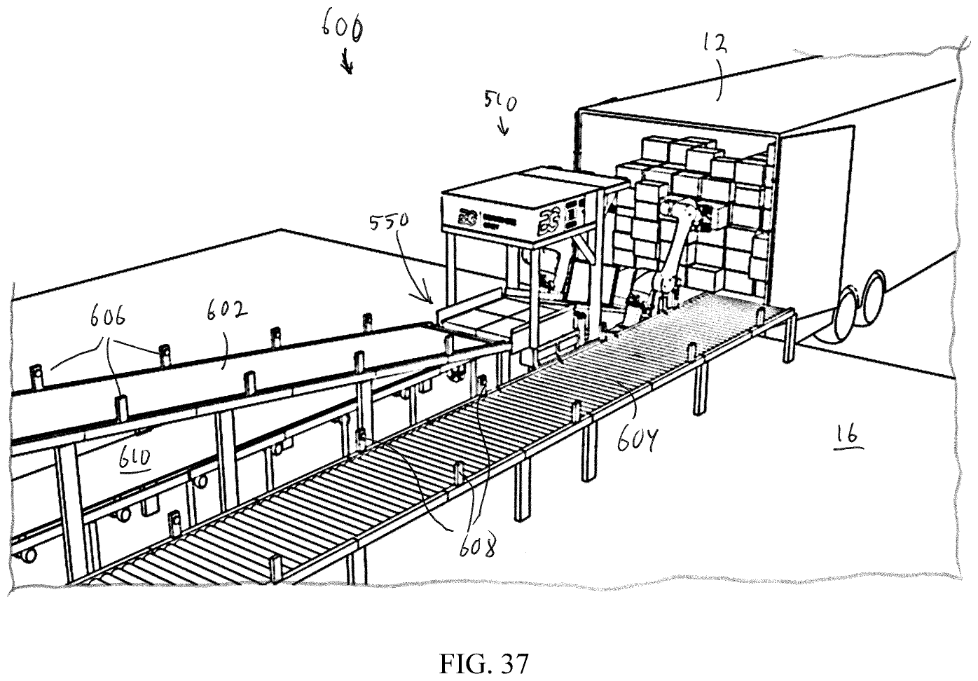

FIG. 37 shows at 600 the object processing system 510 entering (under the control of the one or more computer processing systems) the trailer 12 from the loading dock 16. An exceptions conveyor 604 is provided to receive (e.g., via human personnel) articles and packages that may not be processible by the system 510, for example, due to being of a large size or heavy weight or oddly shaped (e.g., tires). The exceptions conveyor may be provided on one or both sides of the system 510. The exceptions conveyor(s) 604 includes one or more exceptions perception systems 608 to monitor the rate of flow of exceptions along the exceptions conveyor 604. Objects that are processed by the system 510 will be provided to a fixed position facility intake conveyor 602, and the facility intake conveyor includes one or more intake perception systems 606 to monitor the rate of intake of objects along the facility intake conveyor 602. A traveling conveyor 610 is coupled to and moves with the system 510 near the transition conveyor 550 such that objects are readily moved from the transition conveyor 550 to the traveling conveyor 610 during object processing.

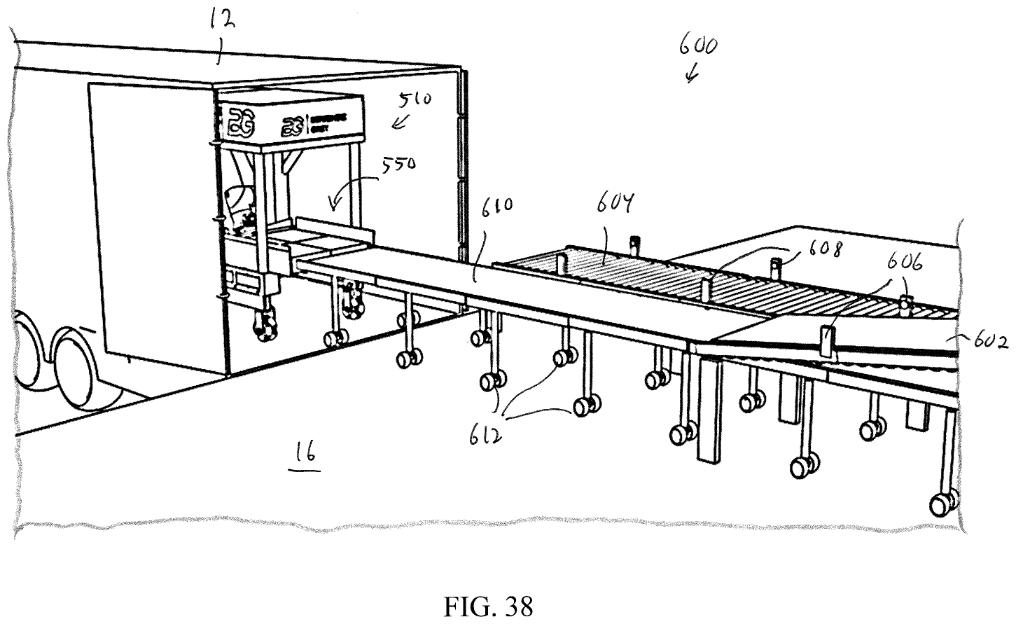

The traveling conveyor 610 is arranged under the facility intake conveyor 602 but is not attached to the facility intake conveyor 602 such that it may freely travel toward the trailer while still providing objects to the facility intake conveyor 602. With further reference to FIG. 38, when the object processing system 510 enters into the trailer 12 as discussed above, the transition conveyor that is coupled to the system 510 enters the trailer 12 with the system 510. As objects are unloaded (again as discussed above), objects are provided from the transition conveyor 550 to the traveling conveyor 610, and then provided from the traveling conveyor 610 to the facility intake conveyor 602.

Again, the rate of flow of objects along the facility intake conveyor is monitored (as are the rates of flow into the facility from additional trailers). By monitoring these rates of flow, the facility may identify potential backups within the facility in the event that objects are entering the facility at too high a rate. In this way, the (one or more) systems 510 may adjust their rate of removal of objects from the trailer(s) to provide a timing buffer for the facility, ensuring that an efficient flow of objects is being provided within the facility. Similar buffering may be provided by the exceptions conveyor(s).

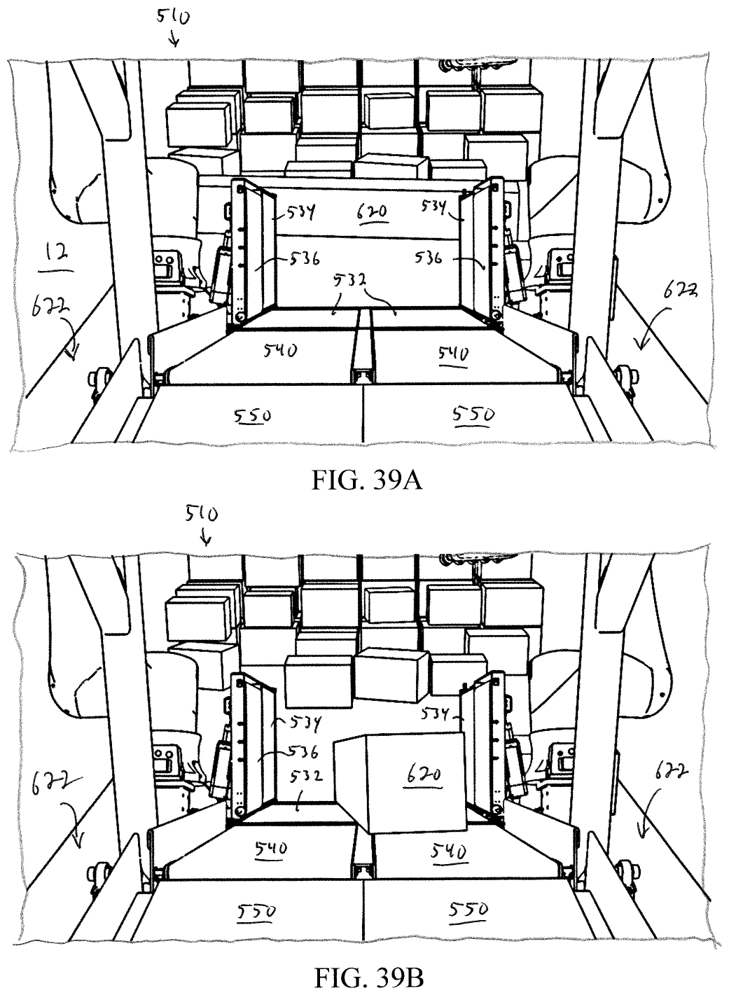

With reference again to FIG. 19, the system may include a plurality of perception systems that are directed toward the interior of the trailer 12 from the object processing system 510. The perception systems 552, together with the one or more computer processing systems, may be used to identify whether retention devices (such as straps, netting or braces) are present within the trailer, requiring the intervention of human personnel. In this case, the conveyor sections 534, 536 are raised as shown in FIG. 39A, permitting human personnel to enter the trailer and move past the system 510 to access (and remove) the detected retention device. In the systems of FIGS. 1-18, one of the guide panels may open, permitting entry of human personnel.

The perception systems 552 may also detect the presence of an exception (again an object that is too large, too heavy or formed of a shape that is difficult to process). This determination may also be made based on one or more failed attempts to process the object. When any of this occurs, the system may raise the conveyor sections 534, 536 as shown in FIG. 39A, permitting human personnel to enter the trailer and move past the system 510 to access the exception 620. The human personnel may carry the exception 620 out of the trailer to the exceptions conveyor(s) 604, or the human personnel may place the object onto the conveyor sections 532 as shown in FIG. 39B for processing by the system 510 if appropriate (e.g., it fits on the conveyor sections 532 and is not outside facility size or weight restrictions).

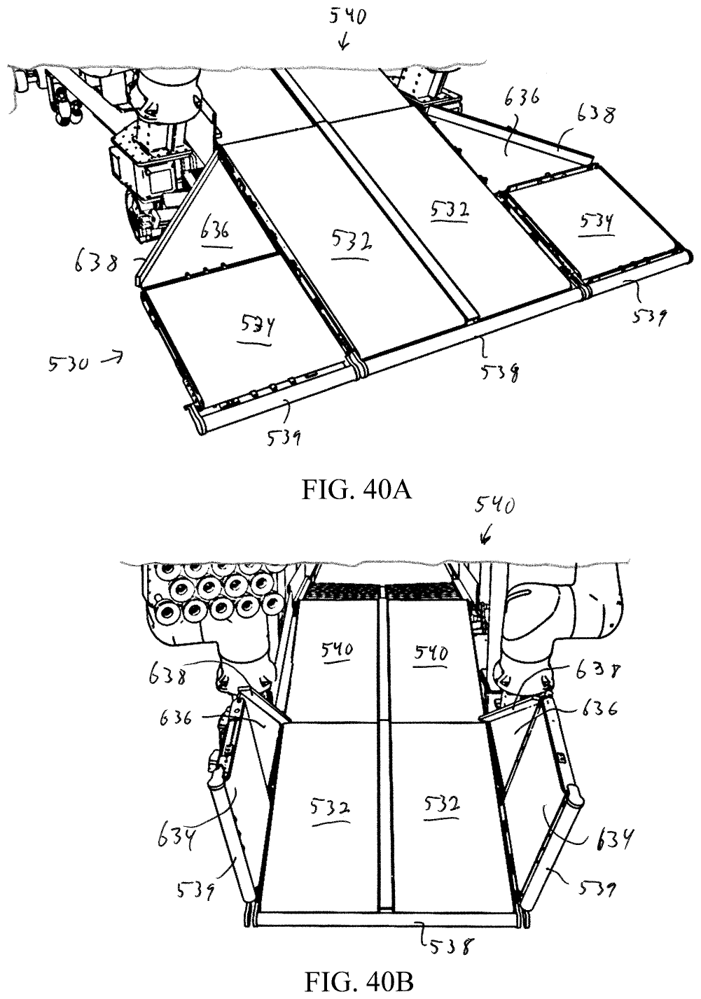

In accordance with further aspects, the object processing system 650 may include conveyor sections 532, 534 as discussed above, but the conveyor sections 536 may be replaced with static guide panels 636 that include guides 638 as shown in FIG. 40A. The guides 638 on the panels 636 should facilitate movement of objects up the conveyor sections to be urged toward a central line of movement through the object processing system 650. The conveyor sections 534 together with the guide panels 636 are also rotatable as shown in FIG. 40B to an upright position for the purposes discussed above, including entering the trailer and permitting human personnel to access the interior of the trailer once the object processing system 650 has entered the trailer for any of removing a retention device or handling an exception. Additionally, when the conveyor sections 534, 636 (as well as 134, 136 of FIG. 10 if raised to a vertical position) are in the vertically raised position as shown in FIGS. 39B and 40B, the conveyors are still operable to facilitate moving objects along the conveyor sections 532 (and 132 of FIG. 10). This may even facilitate clearing any jams on the conveyor sections 532 by using the raised conveyor sections 534, 536 to facilitate moving objects along the conveyor section 532 by contacting the vertical sides of the objects, and the conveyor sections 134, 136 further may be used to facilitate clearing any jams when rotated past vertical as shown in FIG. 11A by possibly contacting top surfaces of objects.

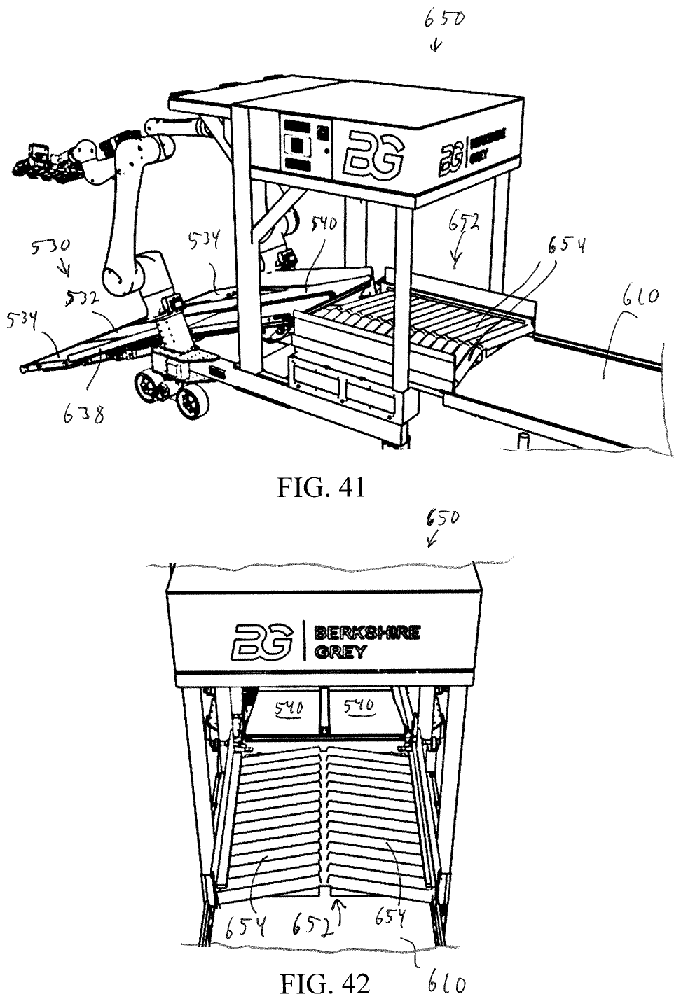

The object processing system 650 may further include a different transition conveyor than the transition conveyor 550 discussed above. In particular and with reference to FIG. 41, the system 650 may include a transition conveyor section 652 that includes a pair of herring bone angled conveyor sections 654 that are angled such that objects that are received from the collecting conveyor 540 are dropped onto the transition conveyor section 652, moved toward the center of the transition conveyor section 652 by the angled rollers, and the dropped onto the traveling conveyor 610 at a generally central location thereof. FIG. 41 shows an elevated side view of the system 650 with the object processing system 650 showing the transition conveyor section 652, and FIG. 42 shows an elevated rear view of the transition conveyor section 652. The transition conveyor section 652 may be used with any of the systems discussed above.

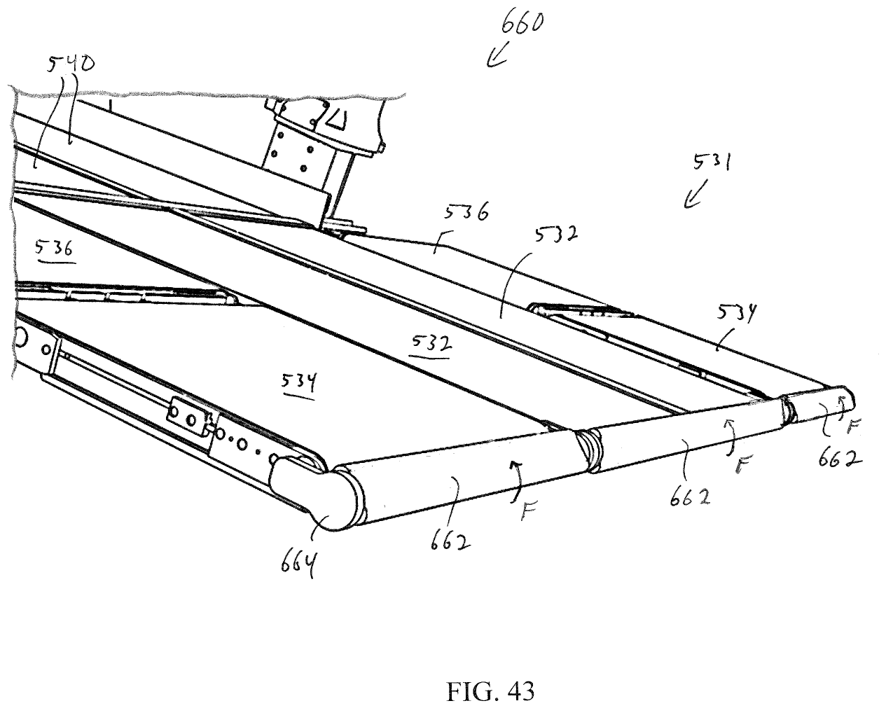

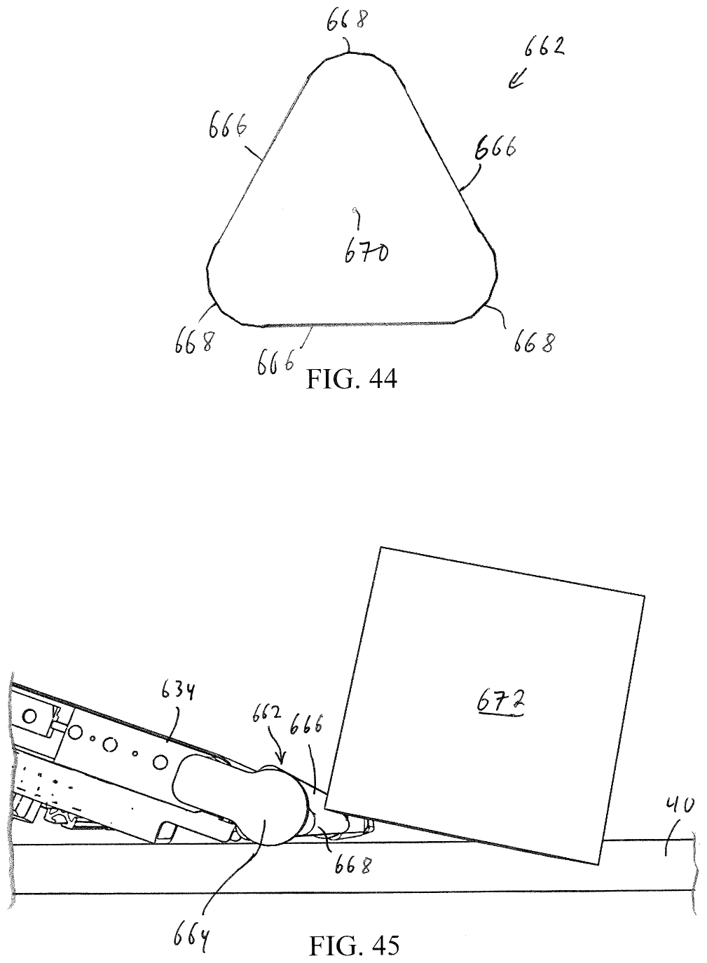

The object processing system may include lead kicker rollers with features that facilitate engagement with objects within the trailer. FIG. 43, for example, shows an object processing system 660 that includes a loading conveyor section 531 with conveyor sections 532, 534, 536 as discussed above as well as shaped kicker rollers 662 in place of the rollers 538, 539 discussed above with reference to FIGS. 19 and 26A-27B. FIG. 44 shows an end view of a roller 662 showing three peaked regions 668 separated by three flat regions 666 forming a generally triangular cross-sectional shape as shown. When the rollers 662 are rotated about their respective centers 670 (shown in FIG. 44) in the direction shown at F in FIG. 43, the rollers 662 may engage an object 672 to be lifted by a peaked region 668 of one or more rollers as shown in FIG. 45. The peaked regions 668 of the rollers 662 may therefor facilitate engagement of the system 660 with objects on a floor 40 of a trailer. As discussed above each roller 662 may be differently or independently driven with respect to the conveyor sections 532, 534.

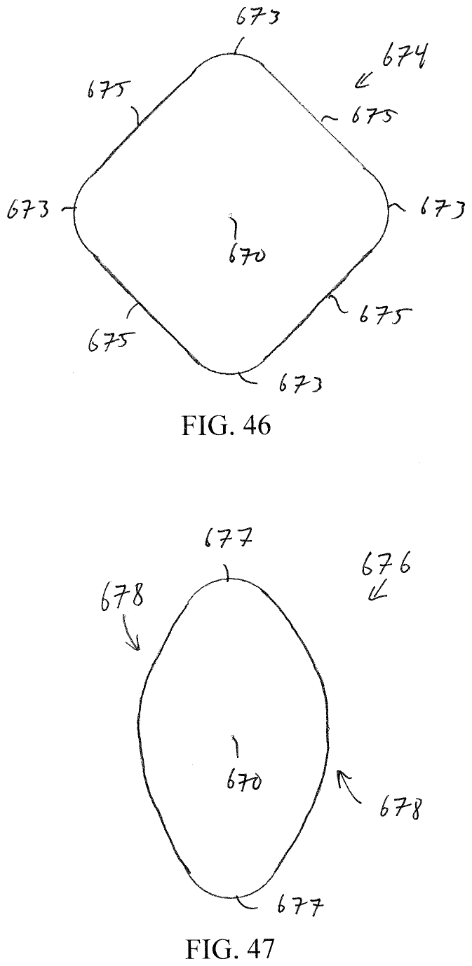

In accordance with further aspects, the kicker rollers may be provided in a variety of shapes and functionalities. For example, FIG. 46 shows a kicker roller 674 that includes four peaked regions 673 separated by four flat regions 675 forming a generally square cross-sectional shape as shown. When the rollers 674 are rotated about their respective centers 670 in the direction shown at F in FIG. 43, the rollers 674 may engage an object to be lifted by a peaked region 673 of one or more rollers. The peaked regions 673 of the rollers 674 may therefor facilitate engagement of the system 660 with objects on a floor 40 of a trailer.

FIG. 47 shows a kicker roller 676 that includes two peaked regions 677 separated by two gently curved regions 678 forming a generally oval cross-sectional shape as shown. When the rollers 676 are rotated about their respective centers 670 in the direction shown at F in FIG. 43, the rollers 676 may engage an object to be lifted by a peaked region 677 of one or more rollers. The peaked regions 677 of the rollers 676 may therefor facilitate engagement of the system 660 with objects on a floor 40 of a trailer.

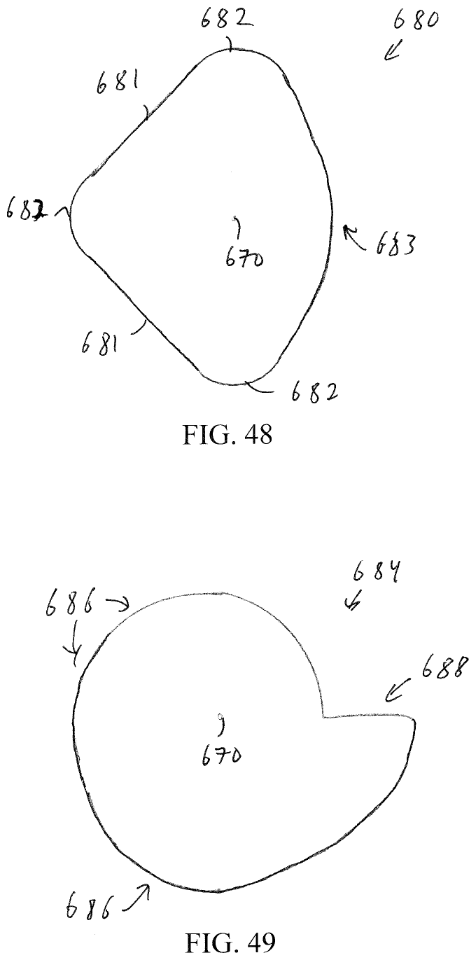

The kicker rollers also need not be symmetric in cross-sectional shape. FIG. 48 shows a kicker roller 680 that includes three peaked regions 682, one of which joins two straight regions 681; the other two peaked regions 682 are joined by a single gently curved region 683 forming an asymmetric outer surface as the roller rotates. When the rollers 684 are rotated about their respective centers 670 in the direction shown at F in FIG. 43, the rollers 684 may engage an object to be lifted by a peaked region 682 of one or more rollers. The peaked regions 682 of the rollers 684 may therefor facilitate engagement of the system 660 with objects on a floor 40 of a trailer.

In accordance with further aspects, the kicker rollers (e.g., any of rollers 538, 539, 662, 674, 676, 680) may be rotated about a point that is not the center of the roller causing the roller to rotate a cam fashion, which may engage an object to be lifted by an outer cam portion of one or more rollers to facilitate engagement of the system 660 with objects on a floor 40 of a trailer.

FIG. 49 shows a kicker roller 684 that includes an elongated outer surface of a gradually increasing radius 686 and a peaked region 688 where the outer surface sharply reduces in radius forming a generally cam-shaped cross-sectional shape as shown. When the rollers 684 are rotated about their respective axis of rotation 670 in the direction shown at F in FIG. 43, the rollers 684 may engage an object to be lifted by the peaked region 688 of one or more rollers. The peaked regions 688 of the rollers 684 may therefor facilitate engagement of the system 660 with objects on a floor 40 of a trailer.

As noted above, each of the rollers 538, 539, 662, 674, 676, 680, 684 may be differently or independently driven with respect to the conveyor sections 532, 534. For example, FIG. 50 shows that the cover 664 includes alignment holes 690 for receiving alignment pins 692 on the support structure of the conveyor section (e.g., conveyor section 534 as shown). The alignment pins 692 in the alignment holes 690 secure the cover 664 to the conveyor section. The kicker roller (e.g., 662 as shown) rotates about an axle 693 that seats in a collar 691 attached to the inner surface of the cover 664. In this way, the rollers (e.g., 538, 539, 662, 674, 676, 680, 684) are rotatably secured to the object processing system (e.g., 510, 660) at both ends thereof.

The kicker rollers (e.g., 538, 539, 662, 674, 676, 680, 684) may be driven from a conveyor section (as shown in FIG. 50) or may be driven by a separate drive system (as shown in FIG. 51). In particular, FIG. 50 shows a belt drive system 694 that connects a first drive wheel 699 that is coupled to a roller of the conveyor section 634 to a second drive wheel 695 that drives the kicker roller 662. The wheels 699, 695 may be different sizes, permitting the kicker roller to rotate at different speeds than the roller of the conveyor section 634. The cover 664 includes a recessed region that covers the belt drive system 694.

FIG. 51 shows a motor drive system 696 within the cover 664. Again, the alignment pins 692 in the alignment holes 690 secure the cover 664 to the conveyor section. The kicker roller (e.g., 662 as shown) rotates about the axle 693 that seats in the collar 691 attached to the inner surface of the cover 664. The motor drive system 696 includes a motor 697 and a drive wheel 698 that engages the drive wheel 695 of the roller (e.g., 662 when the cover 664 is placed over the drive wheel 693 and onto the alignment pins 692.

Using either belt drive system of FIG. 50 or the separate motor drive system of FIG. 51, the kicker rollers may be rotated at different speeds and directions than the rollers of adjacent the conveyor sections. Each roller (e.g., 538, 539, 662, 674, 676, 680, 684) may include the drive system at one or both ends of the roller, and each roller includes a cover supporting the roller as discussed above at both ends thereof.

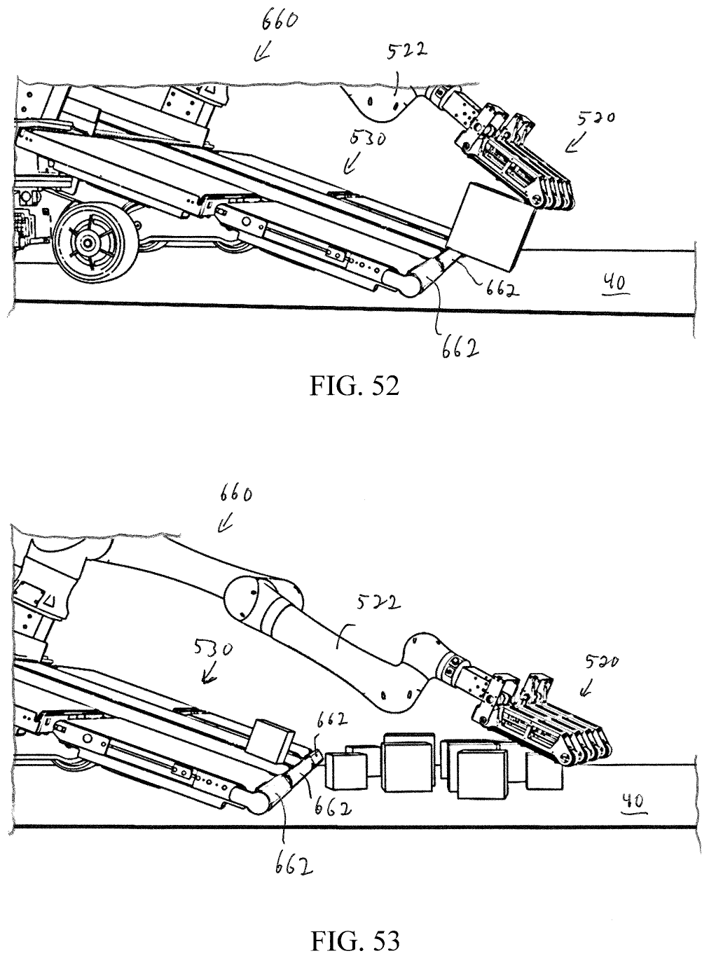

Moving objects onto the kicker roller and lower conveyor sections 530 may further be facilitated by using the end-effector 520. FIG. 52 for example shows the object processing system 660 using the end-effector 520 to urge an object onto the kicker roller 662 (and thereby onto the loading conveyor sections 530. As further shown in FIG. 53, the end-effector 520 may further be used to urge objects on the floor 40 of trailer toward the loading conveyor section 530 and onto the kicker rollers 662. In particular, the end-effector 520 may be used to urge objects along the floor 40 by pushing a plurality of objects at a time as the objects move toward to the loading conveyor sections 520, and lighter objects may be pushed over heavier objects onto the loading conveyor section 520.

Those skilled in the art will appreciate that numerous modifications and variations may be made to the above disclosed embodiments without departing from the spirit and scope of the present invention.

What is claimed is:

1. An object processing system comprising:
a mobile unit for moving from a proximal base toward a plurality of objects to be processed; and
a programmable motion device supported on the mobile system at a proximal end of the programmable motion device, the programmable motion device including an end-effector at a distal end thereof, the end-effector including a first portion that remains stationary with respect to the distal end of the programmable motion device, and a second movable portion that moves with respect to the first portion, the second movable portion for contacting at least one object of the plurality of objects for urging the at least one object from the plurality of objects toward the mobile system.

2. The object processing system as claimed in claim 1, wherein the second moving portion includes a conveyor that contacts the at least one object of the plurality of objects.

3. The object processing system as claimed in claim 2, wherein the conveyor includes features thereon that contact the at least one object on an underside thereof.

4. The object processing system as claimed in claim 2, wherein the conveyor operates in a direction wherein the underside of the conveyor moves toward the programmable motion device.

5. The object processing system as claimed in claim 2, wherein the conveyor is operable in either of two directions.

6. The object processing system as claimed in claim 5, wherein the conveyor includes two mutually opposing conveyor faces, either of which may be used for contacting the at last one object.

7. The object processing system as claimed in claim 2, wherein the conveyor is mounted to the programmable motion device at other than a central location on the conveyor, facilitating accessing a wider area.

8. The object processing system as claimed in claim 1, wherein the end-effector includes a plurality of finger units, each including a conveyor.

9. The object processing system as claimed in claim 8, wherein each of the plurality of finger units is rotatable with respect to the programmable motion device.

10. The object processing system as claimed in claim 8, wherein each of the conveyors includes engagement features for engaging objects.

11. The object processing system as claimed in claim 2, wherein the end-effector further includes a secondary tool mounted on one side of the conveyor for contacting an obstruction within the plurality of objects.

12. The object processing system as claimed in claim 8, wherein the secondary tool includes at least one vacuum cup coupled to a vacuum source.

13. The object processing system as claimed in claim 1, wherein the object processing system includes a primary conveyance system for conveying objects under the programmable motion device toward the proximal base.

14. The object processing system as claimed in claim 10, wherein the proximal base is a back end of a tractor trailer.

15. The object processing system as claimed in claim 8, wherein the object processing system includes two sets of freely pivotable drive wheels.

16. The object processing system as claimed in claim 8, wherein the object processing system includes a loading conveyor that is extendable in a direction of a width of a trailer of a tractor trailer.

17. An object processing system comprising a programmable motion device with an end-effector, said end-effector comprising a conveyor section wherein the conveyor section includes features for contacting an object of a plurality of objects on an underside of the end-effector and thereby urging the object toward the programmable motion device.

18. The object processing system as claimed in claim 17, wherein the conveyor is operable in either of two directions.

19. The object processing system as claimed in claim 18, wherein the conveyor includes two mutually opposing conveyor faces, either of which may be used for contacting the at last one object.

20. The object processing system as claimed in claim 17, wherein the conveyor is mounted to the programmable motion device at other than a central location aligned with a base or the programmable motion device, facilitating accessing a wider area.

21. The object processing system as claimed in claim 17, wherein the conveyor section may be rotated at least 180 degrees with respect to the programmable motion device.

22. The object processing system as claimed in claim 17, wherein the end-effector includes a plurality of finger units, each including a conveyor.

23. The object processing system as claimed in claim 22, wherein each of the plurality of finger units is rotatable with respect to the programmable motion device.

24. The object processing system as claimed in claim 22, wherein each of the conveyors includes engagement features for engaging objects.

25. The object processing system as claimed in claim 22, wherein the end-effector further includes a secondary tool mounted on one side of the conveyor for contacting an obstruction within the plurality of objects.

26. The object processing system as claimed in claim 22, wherein the secondary tool includes at least one vacuum cup coupled to a vacuum source.

27. The object processing system as claimed in claim 17, wherein the object processing system includes a primary conveyance system for conveying objects under the programmable motion device toward the proximal base.

28. The object processing system as claimed in claim 27, wherein the proximal base is a back end of a tractor trailer.

29. The object processing system as claimed in claim 22, wherein the object processing system includes two sets of freely pivotable drive wheels.

30. The object processing system as claimed in claim 22, wherein the object processing system includes a loading conveyor that is extendable in a direction of a width of a trailer of a tractor trailer.

31. A method of processing objects from a distal plurality location to a proximal base location said method comprising:
engaging at least one object of a plurality of objects at the distal plurality location with an underside of a conveyor section; and
urging the object toward the proximal base location.

32. The method of claim 31, wherein the conveyor section is coupled to a programmable motion device for moving the conveyor section in at least two degrees of freedom.

33. The method of claim 32, wherein the method further includes rotating the conveyor section at least 180 degrees with respect to the programmable motion device.

34. The method of claim 31, wherein the method further includes engaging an obstruction at the distal plurality location with a secondary pulling system coupled to the conveyor section.

35. The method of claim 31, wherein the method further includes rotating at least one finger unit an end-effector that engages the at least one object of the plurality of objects.

36. The method of claim 35, wherein the at least one finger includes a belted conveyor with a plurality of engagement features.

37. The method of claim 31, wherein a rate of flow of objects from a trailer using the conveyor section is monitored and adjusted responsive to facility processing flow data from an object processing facility.

38. The method of claim 31, wherein a flow of objects from a trailer using the conveyor section is centered on a traveling conveyor using a pair of angled rollers.
